(19) United States
(12) Patent Application Publication
(10) Pub. No.: US 2026/0219439 A1
(43) Pub. Date: Jul. 30, 2026

(54) OPTICAL ELEMENTS FORMED FROM HIGH REFRACTIVE INDEX ORGANIC SOLID CRYSTAL COMPOSITES

(71) Applicant: Meta Platforms Technologies, LLC, Menlo Park, CA (US)

(72) Inventors: Liliana Ruiz Diaz, Seattle, WA (US); Hend Baza, Redmond, WA (US); Lafe Joseph Purvis, II, Redmond, WA (US); Sheng Ye, Redmond, WA (US); Renate Eva Klementine Landig, Kirkland, WA (US); Prathmesh Deshmukh, Redmond, WA (US); Christopher Yuan Ting Liao, Seattle, WA (US); Andrew John Ouderkirk, Kirkland, WA (US); Arman Boromand, Sammamish, WA (US); Aniruddha Anantsen Upadhye, Redmond, WA (US); William Arthur Hendrickson, Woodbury, MN (US); Christopher John Rueb, Saint Paul, MN (US)

(21) Appl. No.: 19/418,332

(22) Filed: Dec. 12, 2025

Related U.S. Application Data
(60) Provisional application No. 63/751,103, filed on Jan. 29, 2025.
(60) Provisional application No. 63/751,098, filed on Jan. 29, 2025.

(51) Int. Cl. F21V 8/00; C08K 5/00

(52) U.S. Cl. CPC G02B 6/0065; C08K 5/00; C08K 2201/005

(57) ABSTRACT

A composite material includes a polymer matrix and particles of an organic solid crystal material dispersed throughout the polymer matrix, where the particles constitute 10 to 90 percent by weight of the composite material, and the composite material has a refractive index of 1.7 to 2.7 along at least one dimension.

### CROSS-REFERENCE TO RELATED APPLICATIONS

This application claims the benefit of priority under 35 U.S.C. §119(e) of U.S. Provisional Application No. 63/751,098, filed January 29, 2025, and U.S. Provisional Application No. 63/751,103, filed January 29, 2025, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a schematic illustration of example organic solid crystal (OSC) particle geometries according to some embodiments.

FIG. 2 shows a high refractive index composite structure including nanoscale OSC particles distributed throughout a polymer matrix and the impact of OSC particle loading on a refractive index of the composite according to some embodiments.

FIG. 3 shows compositions and structures of organic solid crystal precursor compounds according to some embodiments.

FIG. 4 depicts compositions and structures of organic solid crystal precursor compounds according to further embodiments.

FIG. 5 shows compositions and structures of organic solid crystal precursor compounds according to still further embodiments.

FIG. 6 depicts example small molecule OSC precursor compounds according to certain embodiments.

FIG. 7 illustrates the impact of OSC particle morphology on the optical properties of high refractive index composite structures according to some embodiments.

FIG. 8 shows high refractive index composite structures with embedded nanoscale organic solid crystal particles according to some embodiments.

FIG. 9 shows example optical elements including an organic solid crystal-based composite material according to some embodiments.

FIG. 10 depicts multilayer optical elements including layers of an organic solid crystal-based composite material according to certain embodiments.

FIG. 11 depicts multilayer optical elements including layers of an organic solid crystal-based composite material according to further embodiments.

FIG. 12 shows a lens element including an organic solid crystal-based composite material according to some embodiments.

FIG. 13 shows a lens element including an organic solid crystal-based composite material according to further embodiments.

FIG. 14 depicts planar and non-planar optical elements formed from an organic solid crystal-based composite material according to some embodiments.

FIG. 15 depicts optical elements with varying refractive index formed from an organic solid crystal-based composite material according to further embodiments.

FIG. 16 shows an optical element having a grating structure formed from an organic solid crystal-based composite material according to some embodiments.

FIG. 17 is an illustration of an example artificial-reality system according to some embodiments of this disclosure.

FIG. 18 is an illustration of an example artificial-reality system with a handheld device according to some embodiments of this disclosure.

FIG. 19A is an illustration of example user interactions within an artificial-reality system according to some embodiments of this disclosure.

FIG. 19B is an illustration of example user interactions within an artificial-reality system according to some embodiments of this disclosure.

FIG. 20A is an illustration of example user interactions within an artificial-reality system according to some embodiments of this disclosure.

FIG. 20B is an illustration of example user interactions within an artificial-reality system according to some embodiments of this disclosure.

FIG. 21 is an illustration of an example wrist-wearable device of an artificial-reality system according to some embodiments of this disclosure.

FIG. 22 is an illustration of an example wearable artificial-reality system according to some embodiments of this disclosure.

FIG. 23 is an illustration of an example augmented-reality system according to some embodiments of this disclosure.

FIG. 24A is an illustration of an example virtual-reality system according to some embodiments of this disclosure.

FIG. 24B is an illustration of another perspective of the virtual-reality system shown in FIG. 24A.

FIG. 25 is a block diagram showing system components of example artificial- and virtual-reality systems.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

Polymer and other organic materials may be incorporated into a variety of different optic and electro-optic device architectures, including passive and active optics and electroactive devices. Lightweight and conformable, one or more polymer/organic solid layers may be incorporated into wearable devices such as smart glasses and are attractive candidates for emerging technologies including virtual reality/augmented reality devices where a comfortable, adjustable form factor is desired.

Mixed reality (MR) and augmented reality (AR) eyewear devices or headsets, for instance, may enable users to experience events, such as interactions with people in a computer-generated simulation of a three-dimensional world or viewing data superimposed on a real-world view. By way of example, superimposing information onto a field of view may be achieved through an optical head-mounted display (OHMD) or by using embedded wireless glasses with a transparent heads-up display (HUD) or augmented reality (AR) overlay. MR/AR eyewear devices and headsets may be used for a variety of purposes. For example, governments may use such devices for military training, medical professionals may use such devices to simulate surgery, and engineers may use such devices as design visualization aids.

In optoelectronics, state of the art materials include inorganic, liquid crystal, and polymer materials. However, these materials are quickly reaching their application limits due to issues such as weight, limited refractive index, limited birefringence, and lack of tunability. Due to current materials limitations, devices are restricted in size/weight, optoelectronic performance, such as angular bandwidth and resolution, and manufacturability. Small molecular solid organic materials allow for the formation of novel active and passive optoelectronic elements that can be cheap, and light weight.

As used here, organic solid crystals include a class of organic compounds that form solid crystalline structures. The molecular structure of the organic solids allows for flexibility, facile modification, and a broad range of potential functionalities and applications. Organic solid crystals possess a range of properties that make them attractive for use in various technologies.

One characteristic of organic solid crystals is their electrical properties. Many organic crystals are semiconductors. This makes them suitable for use in electronic devices such as transistors, sensors, and memory storage systems. Another important attribute of organic solid crystals is their optical properties. These materials may have a large refractive index (n>1.5) and often exhibit fluorescence and absorption in the visible and infrared spectrums, allowing them to be used in light-emitting devices, displays, and photo detectors. Their ability to emit light efficiently makes them valuable in applications such as organic light-emitting diodes.

In addition, organic crystals are often more mechanically compliant than inorganic materials, which opens up possibilities for flexible electronics and wearable devices. Their low density also contributes to their lightweight nature making them ideal for portable and wearable technologies.

The properties of organic solid crystals may be tunable. By adjusting the molecular structure of these materials, their electronic and optical characteristics can be modified in real time to meet specific needs, allowing for greater customization in various applications.

As disclosed herein, particles of an organic solid crystal (OSC) material may be used in the design and manufacture of commercially relevant devices and systems. The size and shape of the OSC particles may be configured to provide one or more advantageous characteristics, including one or more of a controllable refractive index and birefringence, optical clarity, and optical transparency. The OSC particles may be nanometer scale or micrometer scale particles, for example, having any suitable shape, such as spheres, plates, disks, rods, etc.

Various synthesis methods may be used to form OSC particles and composite materials including OSC particles. According to some embodiments, OSC particles may be formed via nucleation and growth from solution or melt. Illustrative methods include crystallization from a saturated solution of one or more precursor compounds and/or solvent evaporation from a solution of one or more precursor compounds. In example methods, OSC particles may be formed by cooling a supersaturated solution or via solvent evaporation of a supersaturated solution. Further synthesis methods include vapor deposition of a precursor solution.

In certain embodiments, a precursor solution may be exposed to ultrasonic waves (> 5 kHz) that are arranged to induce nucleation within the solution. A residence time and temperature to control the growth rate of nascent crystals may be selected, e.g., based on the chosen organic molecule(s). By way of example, a supersaturated solution of 2H-1,2,3-triazole-4,5-dicarbonitrile in water may be prepared at ~25°C (room temperature), heated to 70°C, and sonicated while located within a room temperature water bath to obtain crystals having a mean particle size of approximately 500 nm.

In some embodiments, OSC particles may be manufactured from an emulsion of an OSC solution containing micrometer scale or nanometer scale droplets of precursor dispersed in an immiscible solvent. The emulsion may be contained within the channels of a microfluidic device. The temperature of the emulsion may be controlled to allow a desired droplet size to form prior to nucleation. The emulsion flow rate and the channel dimensions may be controlled to influence the droplet size. The emulsion may be cooled to encourage nucleation and crystal growth. The OSC particles may be collected and dried.

According to further embodiments, OSC particles may be formed via reprecipitation, where a low concentration solution of precursor molecules is injected into a miscible antisolvent. The concentration of the solution and a spinning velocity of the antisolvent may be selected to control the size of the resulting OSC particles. In an example process, 5 ml of 10 wt.% 5-chloro-2-methyl-4-isothiazolin-3-one (CMIT) dissolved into N,N-dimethylformamide (DMF) was injected into 100 ml of water spinning at 1500 rpm, forming a distribution of OSC particles having a particle distribution peak at approximately 500 nm.

In addition to the choice of solvent, one or more of the pH of the solution, a heating or cooling rate, a rate and/or type of mixing (e.g., ultrasonic mixing), and the addition of processing aids may be used to manipulate the size and shape of crystals during growth. Particles of an organic solid crystal may crystallize by cooling and/or solvent evaporation.

OSC particles may be single crystal or polycrystalline. A batch of OSC particles may include a polymorphic mixture of crystalline (e.g., single crystal) particles. Organic solid crystal particles may be monomorphic or polymorphic and may have a refractive index of 1.5 or greater along at least one crystalline axis, e.g., 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, or 3.5, including ranges between any of the foregoing values. Particles of an OSC material may include a single molecular composition or two or more co-crystallized molecule types.

In certain embodiments, an induced crystal-to-crystal or crystal-to-amorphous phase transformation may be effective to change a refractive index of the OSC particles. Such a phase transformation may be performed via photoisomerization using UV irradiation. By way of example, all trans-1,6-diphenyl-1,3,5-hexatriene (DPH) particles have a predicted index (nₓ, n_{y}, n_{z}) of [1.55, 1.66, 2.59]. Upon UV irradiation, a mixture of (trans, trans, cis)-, (trans, cis, trans)-, (cis, trans, cis)- and (cis, cis, trans)- isomers may be formed, which may change the effective refractive index of the OSC particles.

In addition to, or in lieu of the foregoing, post-synthesis particle size refinement may include thermally shocking larger particles, where an abrupt change in temperature may induce fracture and, in some embodiments, the formation of an OSC powder from OSC granules. According to further embodiments, larger OSC particles may be milled to produce finer particle sizes. Milling may include dry milling, cryogenic milling, wet milling, media milling, or combinations thereof. In some cases, wet milling may be performed using an organic solvent or a mixture of organic solvents, which may be adapted to disperse OSC particles without dissolving them. In some examples, OSC particles may be milled while dispersed in a polymer solution. In some examples, OSC particles may be milled while dispersed in a monomer solution, followed by solvent removal and polymerization.

In some embodiments, an organic solid crystal material may have a density of 1.1 to 2 g/cm³ and an Abbe number of 2 to 60. In some embodiments, an organic solid crystal-based material may have a transmittance across the visible spectrum (400-700 nm) of at least approximately 80% and a transmittance across the near infrared spectrum (700-2000 nm) of at least approximately 60%.

The organic crystalline phase may be single crystal or polycrystalline. In some embodiments, the organic crystalline phase may include amorphous regions. In some embodiments, the organic crystalline phase may be substantially crystalline. The organic crystalline phase may be characterized by a refractive index along at least one principal axis of at least approximately 1.5 at 589 nm. By way of example, the refractive index of the organic crystalline phase at 589 nm and along at least one principal axis may be at least approximately 1.5, at least approximately 1.6, at least approximately 1.7, at least approximately 1.8, at least approximately 1.9, at least approximately 2.0, at least approximately 2.1, at least approximately 2.2, at least approximately 2.3, at least approximately 2.4, at least approximately 2.5, at least approximately 2.6, at least approximately 2.7, at least approximately 2.8, at least approximately 2.9, at least approximately 3, at least approximately 3.1, at least approximately 3.2, at least approximately 3.3, at least approximately 3.4, or at least approximately 3.5, including ranges between any of the foregoing values.

In some embodiments, OSC particles may have an in-plane refractive index that is greater than an out-of-plane refractive index (e.g., n₁=n₂>n₃, or n₁>n₂ and n₁>n₃). In some embodiments, OSC particles may have an out-of-plane refractive index that is greater than an in-plane refractive index (e.g., n₁=n₂<n₃, or n₁<n₂ and n₁<n₃).

Particles of an OSC material may be 3D printed to form optical elements or other parts. A sintering step may be used to densify the printed structure. Sintering may be effective to remove pores and increase transparency.

As disclosed herein, organic solid crystal (OSC) materials may be incorporated into monolithic bodies, such as optical elements (e.g., lenses, waveguides, and the like) and other structures and may be used in the design and manufacture of commercially relevant devices and systems. For instance, particles of an OSC material may be manufactured and consolidated/densified to form an optical element. The size and shape of the OSC particles may be arranged to provide one or more advantageous characteristics. For instance, according to some embodiments, an optical element formed from particles of an organic solid crystal material may possess one or more of a controllable refractive index and birefringence, optical clarity, and optical transparency. The OSC particles may be nanometer scale or micrometer scale particles, having regular or irregular shapes, such as spheres, plates, disks, rods, etc.

As disclosed herein, organic solid crystal particles may be incorporated into a polymer composite. The polymer composite may include a polymer matrix and particles of an organic solid crystal material dispersed throughout the matrix. The organic solid crystal particles may include nanoscale particles, for example, having an average particle size of 20, 30, 40, 50, 60, 70, 80, 90, or 100 nm, including ranges between any of the foregoing values.

According to some embodiments, OSC particles may be formed and then combined with a suitable polymer to form to form a composite material. For instance, nanoscale OSC particles may be blended with a polymer or into a polymer solution, e.g., using speed mixing, followed by solvent evaporation.

According to some embodiments, nanoscale OSC particles may be formed and then combined with a monomer or monomer solution, e.g., using speed mixing, followed by polymerization of the monomer. A mixture of OSC particles with a polymer, polymer solution, monomer, or monomer solution may be homogenized, e.g., using a microfluidizer, to deagglomerate the mixture.

According to further embodiments, OSC particles may be formed in situ within a polymer matrix. In one example, sonication such as using an ultrasonic wave probe may be used to induce nucleation in a solution of organic molecules blended with a suitable monomer or polymer. Elastic energy of the polymer matrix as well as temperature and residence time may be used to control crystallization kinetics and the resulting OSC particle size. In a further example, high shear compounding may be carried out using a high-pressure homogenizer to create a uniform distribution of nanometer scale or micrometer scale molten droplets of one or more organic molecule precursors within a polymer matrix. The temperature of the mixture may be controlled to nucleate and grow OSC particles within the polymer matrix. In some embodiments, the composite material may be sintered at a chosen temperature and pressure to control particle size and porosity.

In some embodiments, OSC particles may constitute 10 to 90 percent by weight of a composite material, e.g., 10, 15, 20, 25, 30, 35, 40, 45, 50, 55, 60, 65, 70, 75, 80, 85, or 90 wt.%, including ranges between any of the foregoing values. In some embodiments, a composite material may additionally include up to 10 wt.% of a surfactant, e.g., 0, 2, 4, 6, 8, or 10 wt.% surfactant, including ranges between any of the foregoing values.

In some embodiments, the polymer matrix may include one or more of polycarbonate (PC), polymethyl methacrylate (PMMA), polystyrene (PS), polyphenylene sulfide (PPS), polyfluorene polymer, acrylonitrile butadiene styrene (ABS), polyimide (PI), polyethylene naphthalate (PEN), polyethylene terephthalate (PET), polybutylene naphthalate (PBN), and polybutylene terephthalate (PBT), as well as derivatives thereof. In some examples, the polymer matrix may include a hydrogel polymer.

Organic solid crystal composite materials may be incorporated into devices and systems including passive and active optical waveguides, resonators, lasers, optical modulators, etc. Further example active optics include projectors and projection optics, ophthalmic high index lenses, eye-tracking, gradient-index optics, Pancharatnam-Berry phase (PBP) lenses, microlenses, pupil steering elements, optical computing, fiber optics, rewritable optical data storage, all-optical logic gates, multi-wavelength optical data processing, optical transistors, etc. According to further embodiments, organic solid crystal composite materials may be incorporated into passive optics, such as windows, optical prisms, waveguides, reflective polarizers, refractive/diffractive lenses, and the like. Related optical elements for passive optics may include polarization selective gratings, Fresnel lenses, microlenses, geometric lenses, PBP lenses, optical light pipes, optical diffusers, beamsplitters, and multilayer thin films.

In connection with exemplary devices and applications, a device or system may include an optical element such as a waveguide for guiding light. Notwithstanding recent developments, it would be advantageous to provide lightweight and versatile optical elements that provide an improved viewing experience in associated systems/devices.

As disclosed herein, an optical element may include one or more layers of an organic solid crystal-based composite. An organic solid crystal-based composite includes an organic or inorganic matrix defining a body of an optical element and particles of an organic solid crystal material dispersed throughout the matrix. In exemplary embodiments, such composite materials may be cast or molded to form a lens or an optical substrate, or formed into thin films that may be stacked to form a multilayer. An organic solid crystal-based composite may be configured to provide improved optical properties, including one or more of a controllable refractive index and birefringence, optical clarity, and optical transparency.

In some embodiments, an organic solid crystal-based composite material may have a density of 1.1 to 2 g/cm³ and an Abbe number of 2 to 60. In some embodiments, an organic solid crystal-based composite material may have a transmittance across the visible spectrum (400-700 nm) of at least approximately 80% and a transmittance across the near infrared spectrum (700-2000 nm) of at least approximately 60%.

In some embodiments, the organic crystalline phase may be characterized by a birefringence (Dn), where n₁≠n₂≠n₃, n₁=n₂≠n₃, n₁≠n₂=n₃, or n₁=n₃≠n₂, of at least approximately 0.001, e.g., at least approximately 0.001, at least approximately 0.002, at least approximately 0.005, at least approximately 0.01, at least approximately 0.02, at least approximately 0.05, at least approximately 0.1, at least approximately 0.2, at least approximately 0.3, at least approximately 0.4, at least approximately 0.5, at least approximately 0.6, at least approximately 0.7, at least approximately 0.8, at least approximately 0.9, or at least approximately 1, including ranges between any of the foregoing values. In some embodiments, a birefringent organic crystalline phase may be characterized by a birefringence of less than approximately 0.05, e.g., less than approximately 0.05, less than approximately 0.02, less than approximately 0.01, less than approximately 0.005, less than approximately 0.002, or less than approximately 0.001, including ranges between any of the foregoing values.

An organic solid crystal composite-based substrate or thin film may include a surface that is planar, convex, or concave. In some embodiments, a substrate or thin film may be configured as a microlens or a prismatic lens. For instance, polarization optics may include a microlens that selectively focuses one polarization of light over another. In further embodiments, the surface may include a three-dimensional architecture, such as a periodic surface relief grating.

Various embodiments relate to optical elements formed from composite materials having a polymer matrix and particles of an organic solid crystal (OSC) material dispersed throughout the matrix. These OSC particles, which may be nanoscale or microscale, provide a high refractive index and tunable birefringence, enabling the creation of lightweight, transparent, and versatile optical components.

The composite materials can be engineered for specific optical properties, such as refractive index, density, and transmittance, making them suitable for use in lenses, waveguides, gratings, and multilayer thin films. The disclosure relates also to methods for synthesizing OSC particles and integrating them into polymers, including in situ formation and blending techniques. These advanced composites are particularly advantageous for applications in augmented reality, virtual reality, and wearable devices, where improved optical performance, reduced weight, and customizable form factors are desired. The disclosure describes the fabrication of optical elements with enhanced clarity, reduced chromatic aberration, and greater design flexibility compared to conventional inorganic or polymer optics.

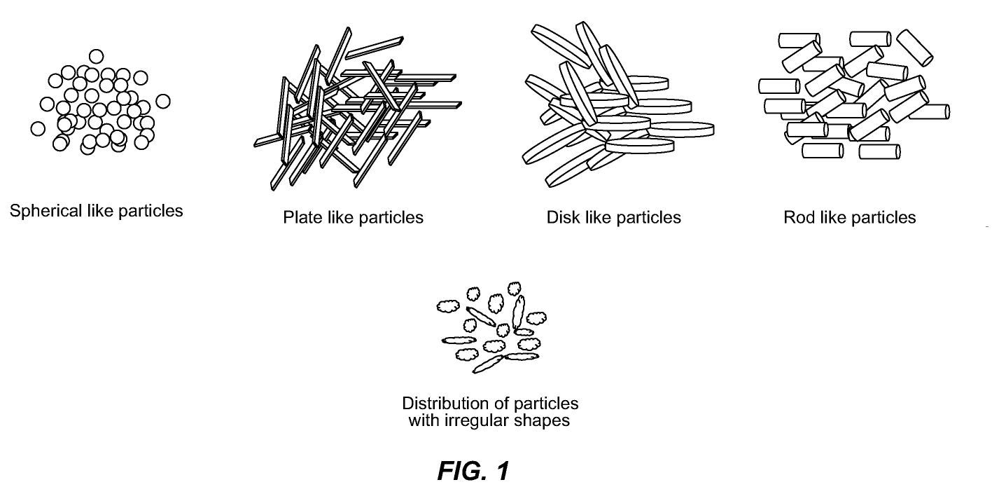

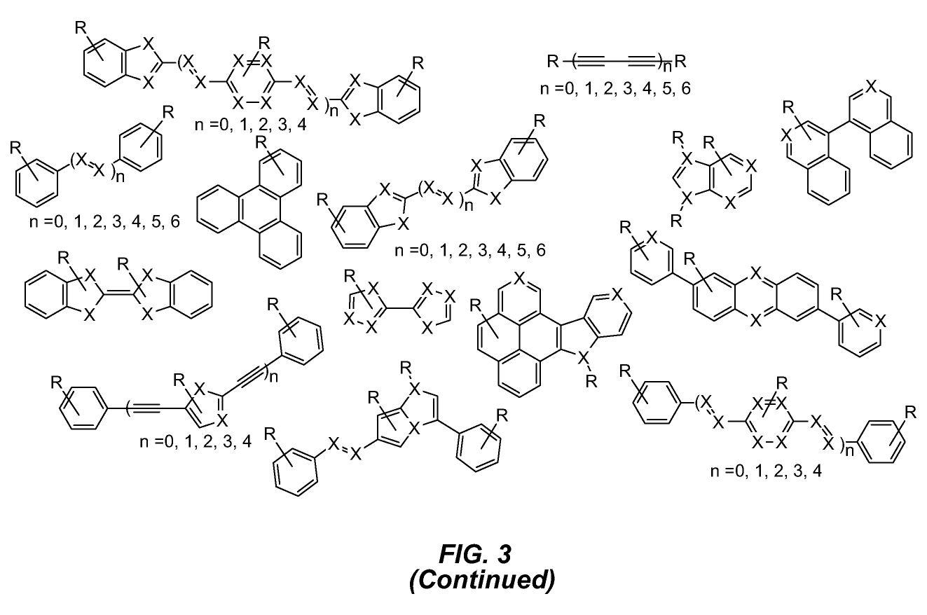

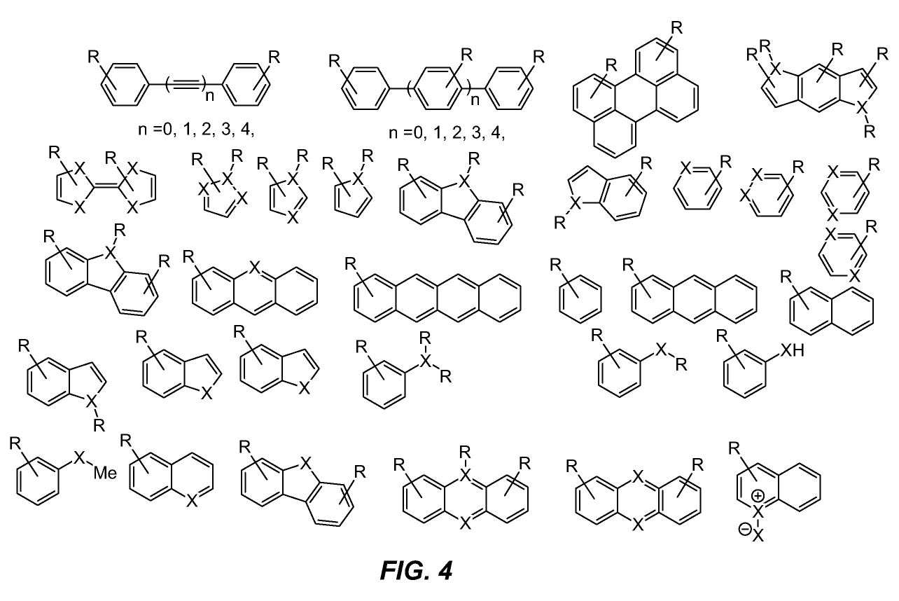

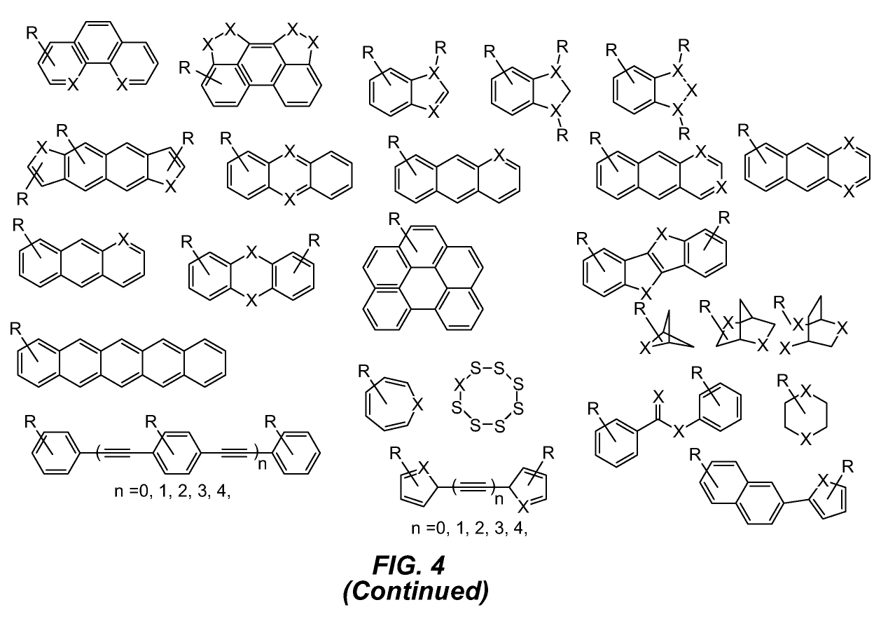

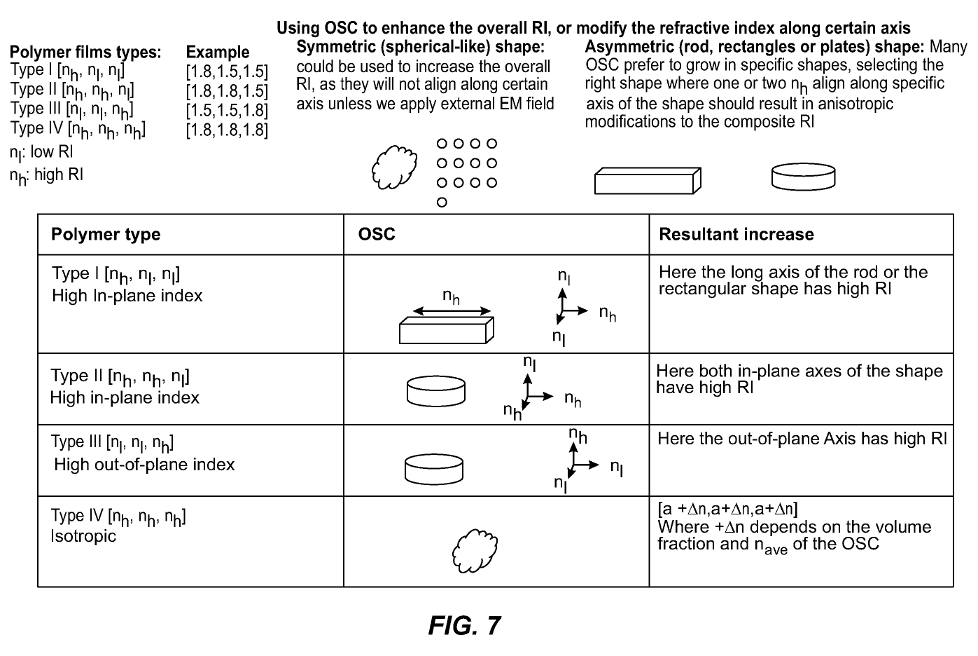

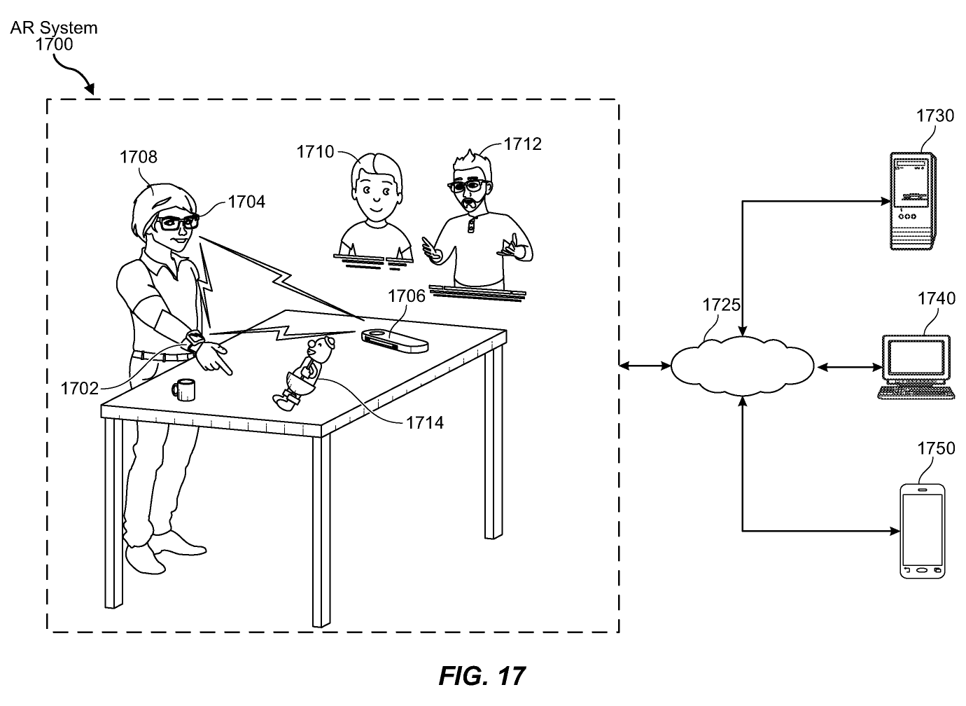

The following will provide, with reference to FIGS. 1-25, detailed descriptions of organic solid crystal (OSC) materials including high refractive index polymer composites formed from nanometer scale or micrometer scale organic solid crystal particles, and optical elements including organic solid crystal-based composite materials for improving the display characteristics of augmented and mixed reality display systems. The discussion associated with FIGS. 1-8 includes a description of example methods for forming nanoscale OSC particles and composite structures including nanoscale OSC particles. The discussion associated with FIGS. 9-16 includes a description of example optical element architectures that include organic solid crystal composites. The discussion associated with FIGS. 17-25 relates to exemplary display devices that may include an OSC composite material as disclosed herein.

In various embodiments, an OSC particle size may range from approximately 10 nm to approximately 10 micrometers, e.g., 10, 20, 50, 100, 200, 500, 1000, 2000, 5000, or 10000 nm, including ranges between any of the foregoing values. In addition, as illustrated in FIG. 1, the shape of an OSC particle or powder is not especially limited, and example OSC particles may be spherical particles, plate like particles, disk like particles, rod like particles, or a distribution of particles having irregular shapes. In some instantiations, a batch of OSC particles may include a mixture of different regular or irregular shapes and sizes.

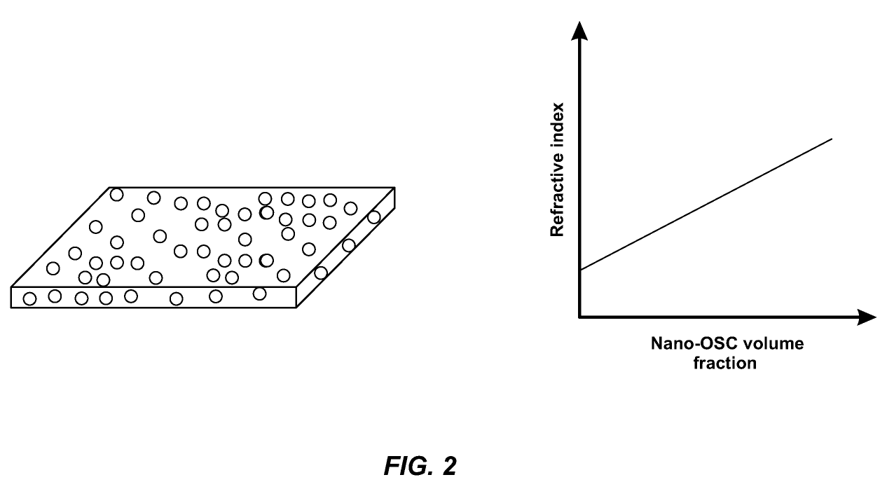

The structure of an OSC-based composite material is depicted in FIG. 2. As shown in FIG. 2A, the composite includes a polymer matrix and a plurality of organic solid crystal particles dispersed throughout the matrix. The effect on refractive index of OSC content within the composite material is shown graphically in FIG. 2B.

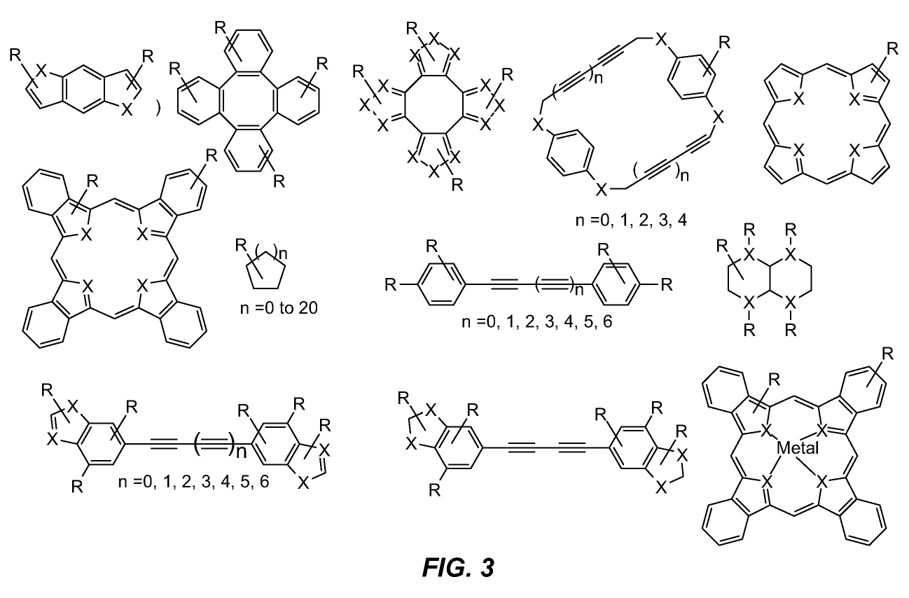

OSC particles may be formed from a variety of molecular precursors. Example precursor materials are illustrated in FIGS. 3-6. As used herein, a “donor” material is an electron-donating or p-type organic material and an “acceptor” material is an electron-accepting or n-type organic material. To form a precursor solution, one or more molecular precursors may be dissolved in a suitable solvent. Example solvents include water, toluene, dimethylformamide (DMF), tetrahydrofuran (THF), methanol, acetone, xylene, pyridine, dichlorobenzene, acetic acid, hexane, cyclohexane, chloroform, N-methyl-2-pyrrolidone (NMP), and the like.

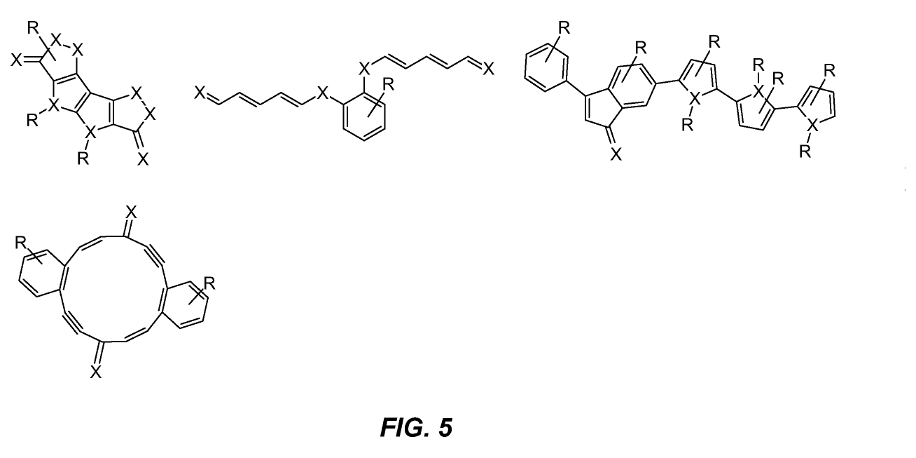

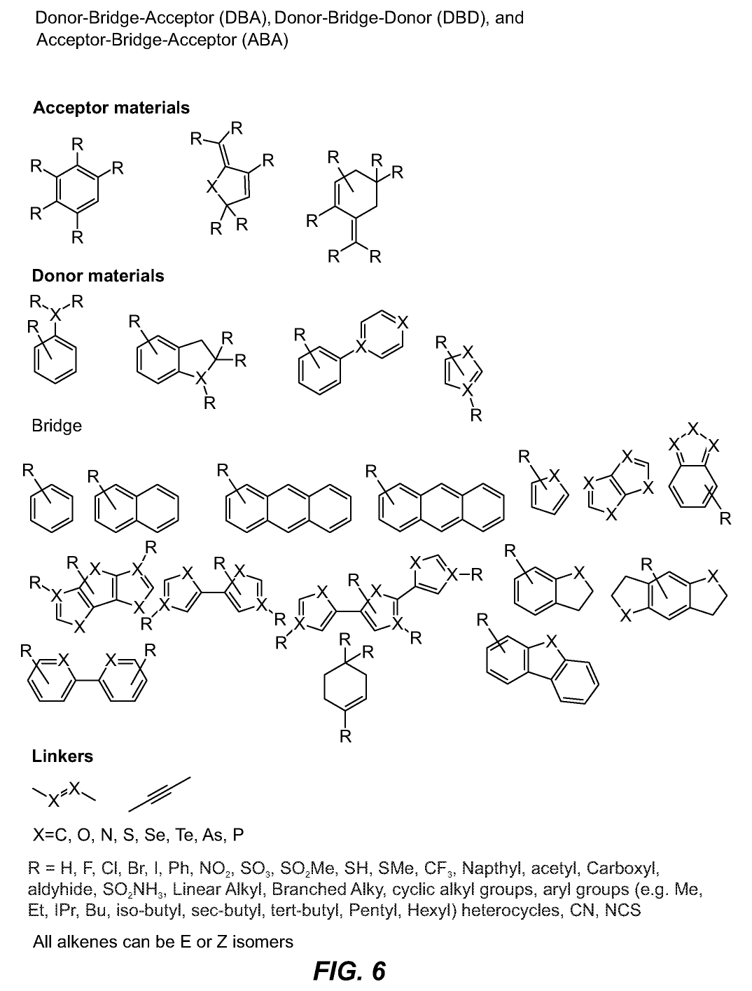

The effect of differently-shaped organic solid crystal particles on the refractive index of various OSC-polymer composites is shown in FIG. 7. In some embodiments, a polymer composite material may be stretched to align organic solid crystal particles within the polymer matrix. The orientation of rod-like OSC particles in a polymer composite due to uniaxially stretching, i.e., along a machine direction (MD), is depicted in FIG. 8A. The in-plane orientation of platelet-like OSC particles in a polymer composite due to biaxial stretching, i.e., along a machine direction (MD) and a transverse direction (TD) is depicted in FIG. 8B.

An OSC-based composite material may be used to form an optical element such as a lens or a waveguide. OSC-based composite materials may advantageously have a higher refractive index (e.g., 1.5<n<3.5) and lower density (1.2<n<2 g/cm³) than comparative polymer and inorganic materials. For instance, an OSC-based composite material may have a refractive index of 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, or 3.5, including ranges between any of the foregoing values. In certain instantiations, a greater number of design configurations may be available for a lens formed from an OSC-based composite material.

An OSC-based composite material may be incorporated into a lens or other optical element in a manner effective to correct chromatic aberration. For instance, highly dispersive OSC composites may be used to increase dispersive power without adding higher diffractive orders or generating stray light. Dispersion characteristics may be designed for a given application. For instance, OSC composites may be used to fabricate achromatic lenses having a specific Abbe number. Lightweight highly dispersive prisms may be formed with significantly greater dispersive power than comparative glass prisms. The OSC composite materials disclosed herein may be used to form lightweight waveguide substrates with a higher field of view than comparative polymer waveguides.

Disclosed are high refractive index composite materials. The composite materials include a polymer matrix and particles of an organic solid crystal (OSC) material dispersed throughout the polymer matrix. The OSC particles may be optically anisotropic and may be characterized by an extraordinary refractive index along a selected direction. The orientation of such particles within the polymer matrix may be arranged to provide a high refractive index along a chosen dimension of the composite. The OSC particles may be shaped as platelets, disks, or rods. Platelets and disks, for example, may have a maximum refractive index aligned in plane or out of plane, and rod-like particles may have a maximum refractive index aligned axially or transverse to the axial dimension. In some embodiments, the OSC particles may be nanoscale particles. Exemplary composite materials may include at least 10 wt.% OSC particles. Extrusion and stretching methods may be used to manufacture optical elements from such high refractive index composite materials.

The structure of a further example OSC-based composite material is depicted in FIG. 9. As shown in FIG. 9A, the composite includes a polymer matrix and a plurality of organic solid crystal particles dispersed throughout the matrix. Additional processing may be used to form a substrate or thin film from the composite material. An OSC-based composite substrate may be shaped as a lens or an optical prism, for example, as shown in FIG. 9B and FIG. 9C, respectively. Alternatively, an OSC-based composite material may be formed as a thin film, as shown in FIG. 9D.

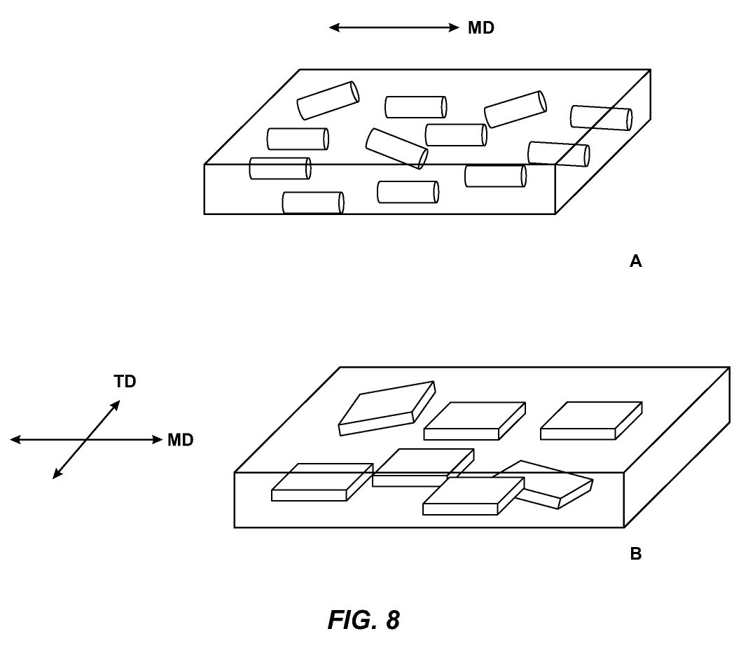

Single layer and multilayer thin films including an OSC-based composite material are depicted in FIG. 10. Example architectures may be configured to include one or more optically isotropic layers, with at least one layer including an OSC-based composite material.

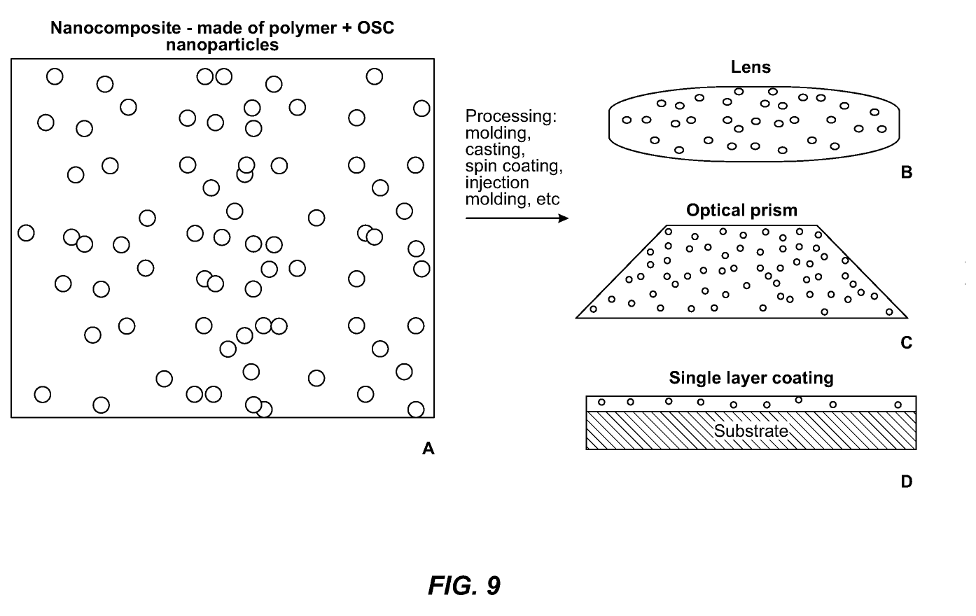

Further single layer and multilayer thin films including an OSC-based composite material are depicted in FIG. 11. Example architectures may be configured to include one or more optically anisotropic layers, with at least one layer including an OSC-based composite material.

In various embodiments, a waveguide body formed from an OSC-based composite material may be co-integrated with any suitable coupling technology, including a geometric waveguide (GWG), a surface relief grating (SRG), a polarization volume hologram (PVH), and/or a volume Bragg grating (VBG).

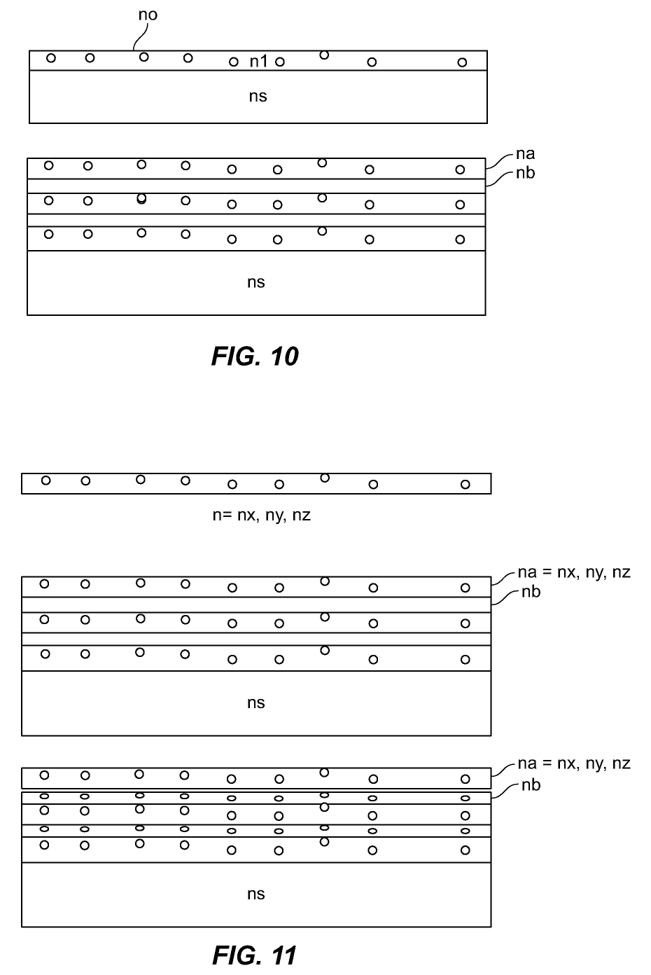

Referring to FIG. 12, shown schematically are comparative and illustrative optical elements. A comparative polymer lens is depicted in FIG. 12A, and an example lens formed from an OSC-based composite material is depicted in FIG. 12B. Lenses may be configured for wearable applications and may include corrective ophthalmological glasses, VR lenses, AR accommodation lenses, and the like.

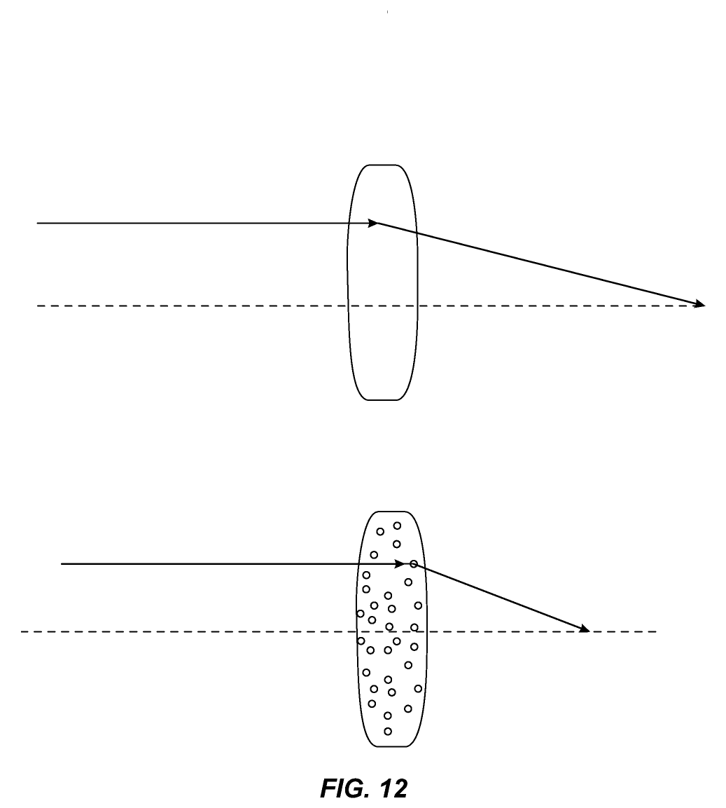

Referring to FIG. 13, an OSC-based composite material may be incorporated into a lens or other optical element in a manner effective to correct chromatic aberration. For instance, highly dispersive OSC composites may be used to increase dispersive power without adding higher diffractive orders or generating stray light. Dispersion characteristics may be designed for a given application. For instance, OSC composites may be used to fabricate achromatic lenses having a specific Abbe number. Lightweight highly dispersive prisms may be formed with significantly greater dispersive power than comparative glass prisms. The OSC composite materials disclosed herein may be used to form lightweight waveguide substrates with a higher field of view than comparative polymer waveguides.

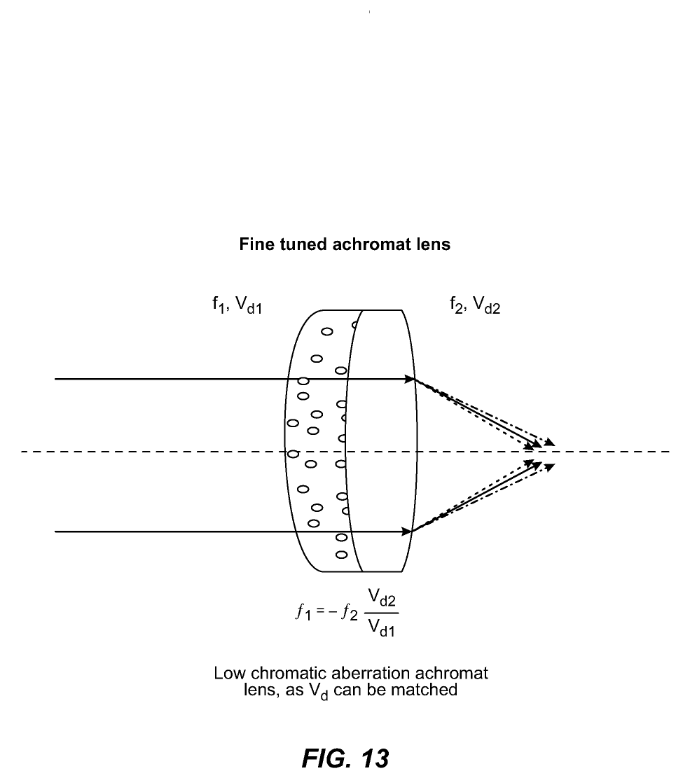

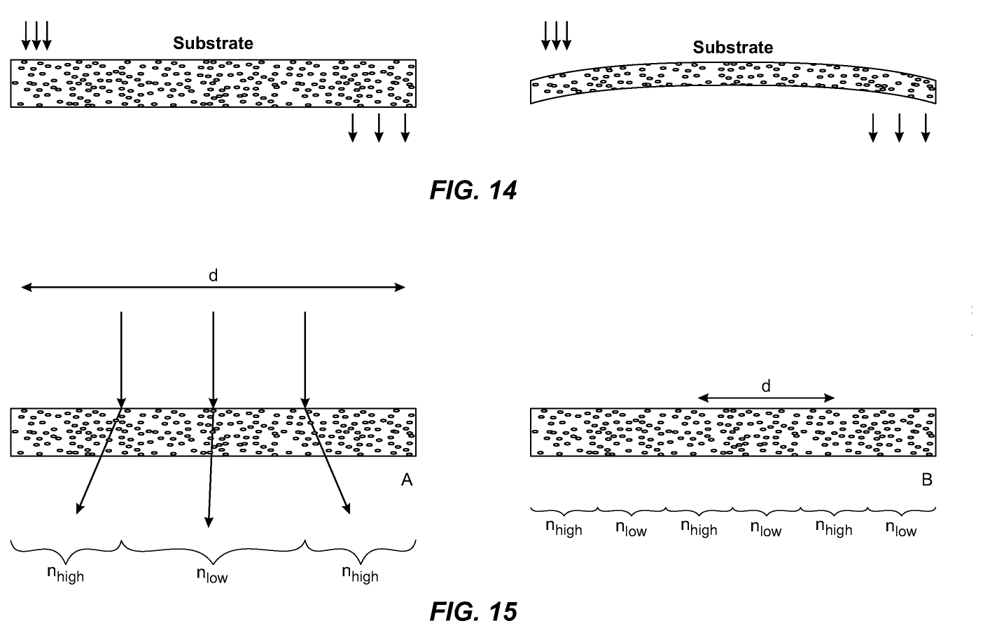

A substrate may include or may be formed from an OSC-based composite material. Example structures are shown schematically in FIGS. 14 and 15, which may include an OSC nanoparticle-based waveguide. In such structures, a refractive index may be constant or variable along one or more dimensions. For instance, a refractive index may vary with spatial location. A gradient refractive index may be achieved by locally changing the density and/or orientation of the OSC particles.

Turning to FIG. 15A, within a substrate formed from an OSC-based composite material, a refractive index difference (Δn) between a region of high refractive index (n_{high}) and a region of low refractive index (n_{low}) may be 0.01 to 0.5, and the spatial distance (d) between adjacent high and low refractive index regions may range from 0.5 to 100 mm. As shown in FIG. 15B, the index difference (Δn) may be 0.01 to 0.5, and the spatial distance (d) may range from 5 to 1000 nm.

Approaches to generating a refractive index gradient, including a periodic refractive index gradient, include engineering a corresponding distribution of OSC particles and localized manipulation of the embedded particles (e.g., using light or heat) to tune their refractive index at desired locations within the composite. Applications for gradient index structures include gradient lenses, monolithic solid-state laser optics, lenses with high dioptric power, fiber collimators, fiber coupling optics, imaging, volume Bragg gratings, etc.

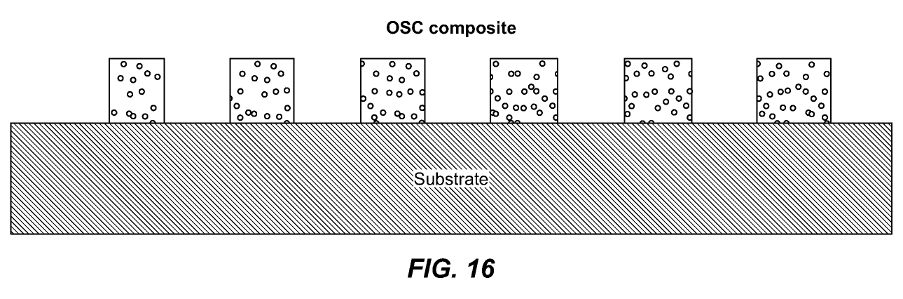

Referring to FIG. 16, individual grating elements with a grating array may be formed from an OSC-based composite material. By way of example, OSC composite gratings may be formed using subtractive or additive processing, such as etching, printing, or laminating.

### Example Embodiments

Example 1: A composite material includes a polymer matrix and particles of an organic solid crystal material dispersed throughout the polymer matrix, where the particles constitute 10 to 90 percent by weight of the composite material, and the composite material has a refractive index of 1.7 to 2.7 along at least one dimension.

Example 2: The composite material of Example 1, where the polymer matrix includes a polymer selected from polycarbonate, polymethyl methacrylate, polystyrene, polyphenylene sulfide, polyfluorene polymer, acrylonitrile butadiene styrene, polyimide, polyethylene naphthalate, polyethylene terephthalate, polybutylene naphthalate, and polybutylene terephthalate.

Example 3: The composite material of any of Examples 1 and 2, where the polymer matrix includes a hydrogel.

Example 4: The composite material of any of Examples 1-3, where the particles include nanoscale particles.

Example 5: The composite material of any of Examples 1-4, where the composite material is optically isotropic.

Example 6: The composite material of any of Examples 1-4, where the composite material is optically anisotropic.

Example 7: The composite material of any of Examples 1-6, where the composite material has a birefringence of 0.001 to 1.

Example 8: The composite material of any of Examples 1-7, where the composite material has a planar structure having an in-plane refractive index greater than an out-of-plane refractive index.

Example 9: The composite material of any of Examples 1-7, where the composite material has a planar structure having an out-of-plane refractive index greater than an in-plane refractive index.

Example 10: The composite material of any of Examples 1-7, where the composite material has a visible spectrum transmittance of at least approximately 80% or a near infrared spectrum transmittance of at least approximately 60%.

Example 11: An optical element includes a substrate configured to guide light and a plurality of diffractive grating elements disposed over the substrate, where the diffractive grating elements include an organic solid crystal composite having a polymer matrix and particles of an organic solid crystal material dispersed throughout the matrix.

Example 12: The optical element of claim 11, where the substrate has a planar surface.

Example 13: The optical element of any of Examples 11 and 12, where the substrate has a non-planar surface.

Example 14: The optical element of any of Examples 11-13, where the diffractive grating elements have a shape selected from slanted, blazed, ruled, and triangular, and have an inter-element spacing of 50 to 1000 nm.

Example 15: A multilayer optical element includes a plurality of alternating first and second layers, where the first layers include an organic solid crystal composite having a polymer matrix and particles of an organic solid crystal material dispersed throughout the matrix.

Example 16: The multilayer optical element of Example 15, where the first layers have a refractive index of at least approximately 1.5 and a birefringence of at least approximately 0.05.

Example 17: The multilayer optical element of any of Examples 15 and 16, where the first layers have refractive indices nx, ny, nz with nx > 1.5, ny > 1.5, and nz > 1.5.

Example 18: The multilayer optical element of any of Examples 15-17, where the first layers are optically isotropic.

Example 19: The multilayer optical element of any of Examples 15-17, where the first layers are optically anisotropic.

Example 20: The multilayer optical element of any of Examples 15-19, where the second layers include an organic solid crystal composite having a polymer matrix and particles of an organic solid crystal material dispersed throughout the matrix.

Embodiments of the present disclosure may include or be implemented in conjunction with various types of Artificial-Reality (AR) systems. AR may be any superimposed functionality and/or sensory-detectable content presented by an artificial-reality system within a user’s physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

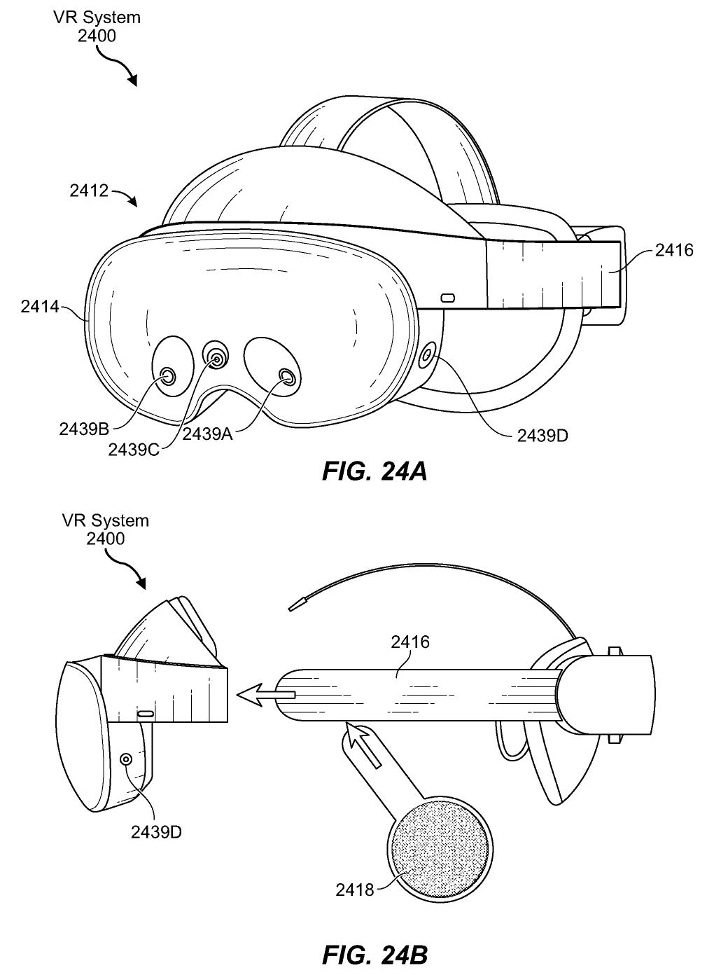

AR systems may be implemented in a variety of different form factors and configurations. Some AR systems may be designed to work without near-eye displays (NEDs). Other AR systems may include a NED that also provides visibility into the real world (such as, e.g., VR system 2400 in FIGS. 24A and 24B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

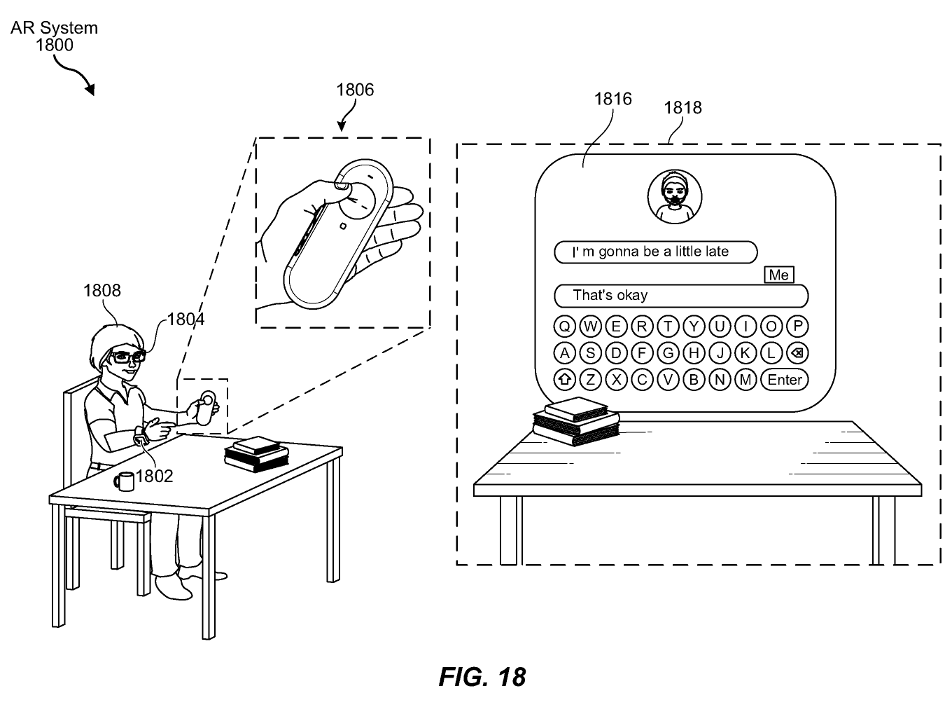

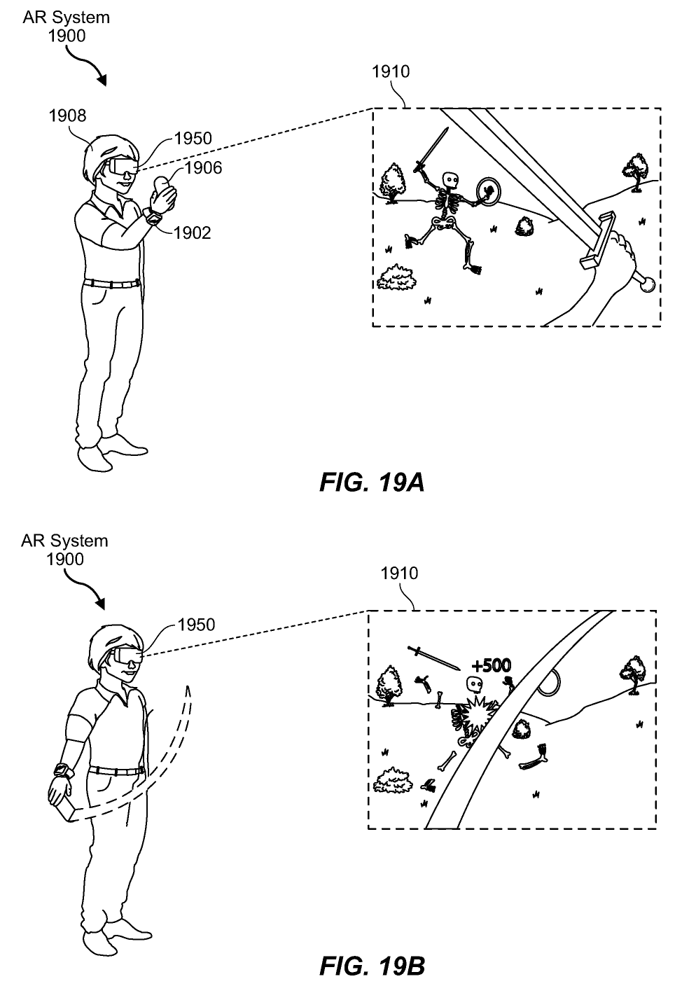

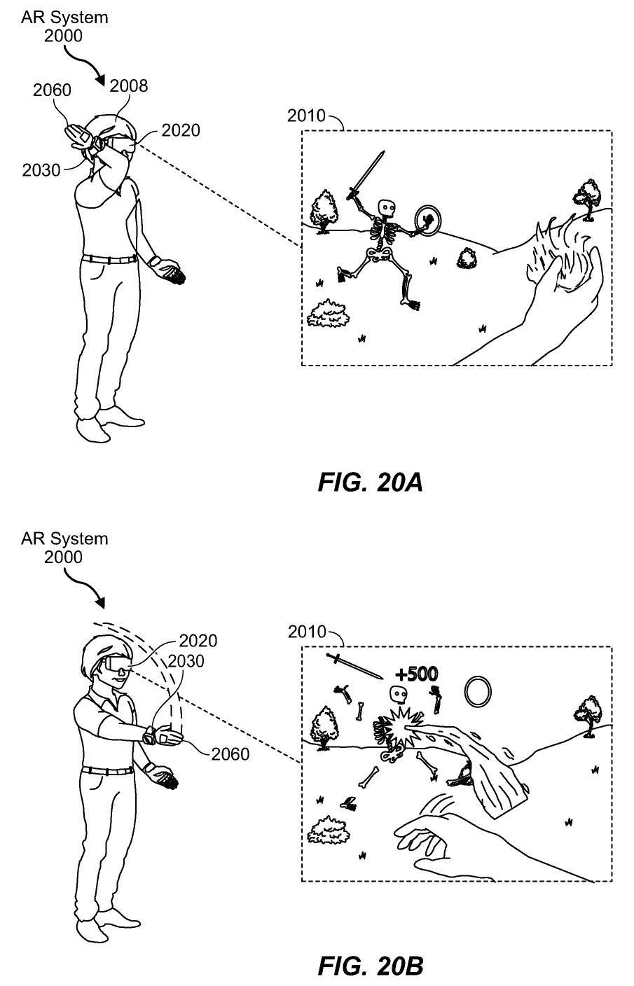

FIGS. 17-20B illustrate example artificial-reality (AR) systems in accordance with some embodiments. FIG. 17 shows a first AR system 1700 and first example user interactions using a wrist-wearable device 1702, a head-wearable device (e.g., AR system 2300), and/or a handheld intermediary processing device (HIPD) 1706. FIG. 18 shows a second AR system 1800 and second example user interactions using a wrist-wearable device 1802, AR glasses 1804, and/or an HIPD 1806. FIGS. 19A and 19B show a third AR system 1900 and third example user 1908 interactions using a wrist-wearable device 1902, a head-wearable device (e.g., VR headset 1950), and/or an HIPD 1906. FIGS. 20A and 20B show a fourth AR system 2000 and fourth example user 2008 interactions using a wrist-wearable device 2030, VR headset 2020, and/or a haptic device 2060 (e.g., wearable gloves).

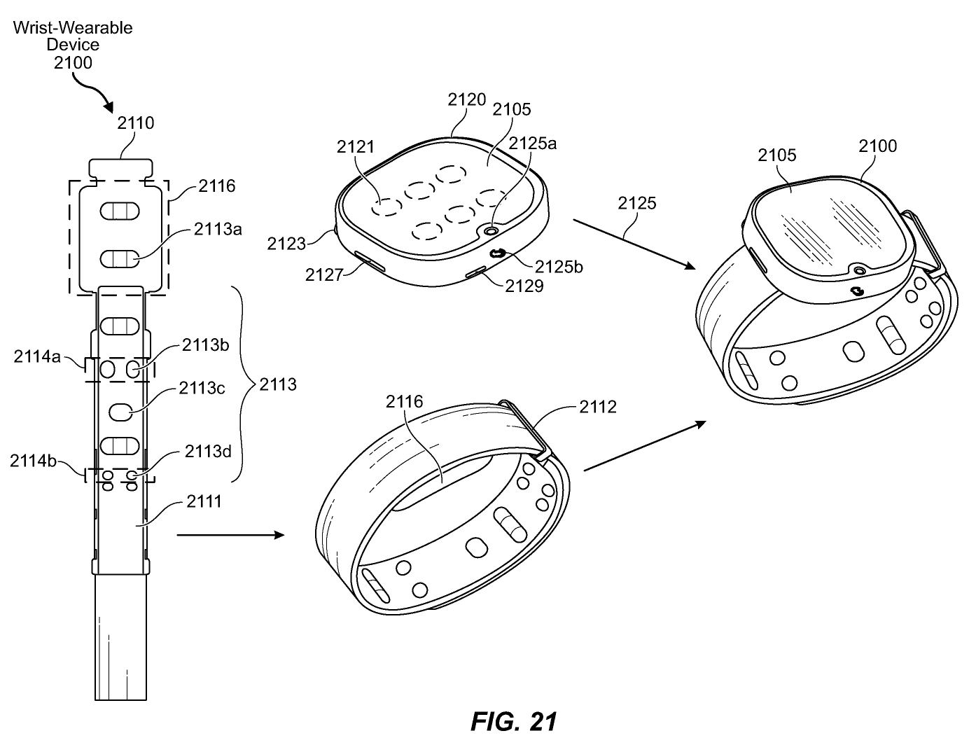

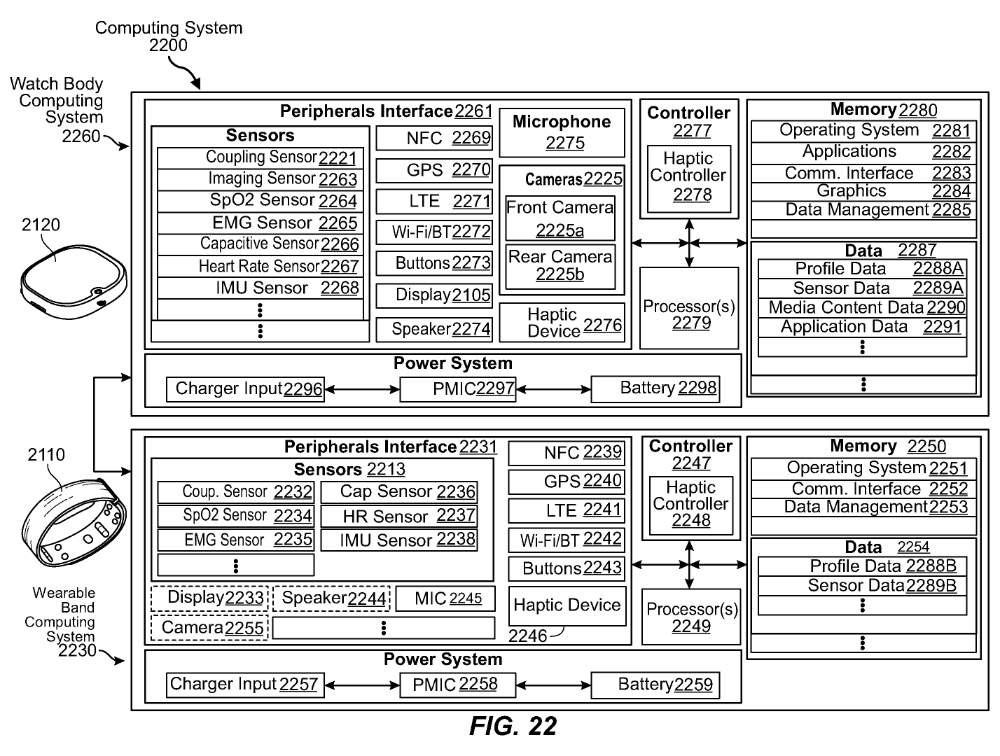

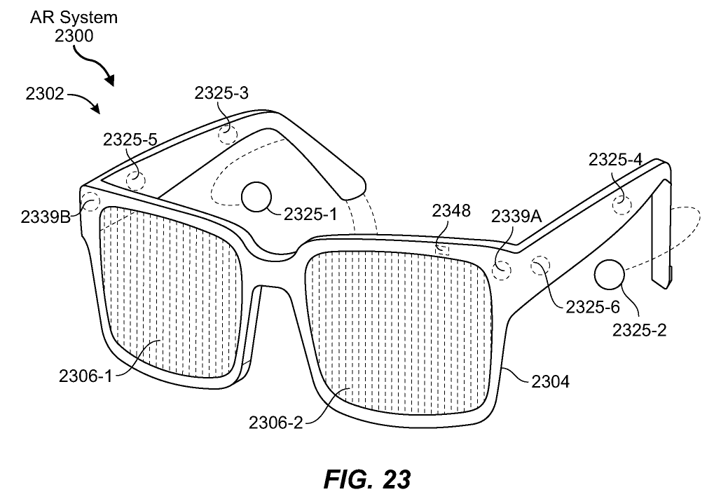

A wrist-wearable device 2100, which can be used for wrist-wearable device 1702, 1802, 1902, 2030, and one or more of its components, are described below in reference to FIGS. 21 and 22; AR system 2300 and VR system 2400, which can respectively be used for AR glasses 1704, 1804 or VR headset 1950, 2020, and their one or more components are described below in reference to FIGS. 23-25.

Referring to FIG. 17, wrist-wearable device 1702, AR glasses 1704, and/or HIPD 1706 can communicatively couple via a network 1725 (e.g., cellular, near field, Wi-Fi, personal area network, wireless LAN, etc.). Additionally, wrist-wearable device 1702, AR glasses 1704, and/or HIPD 1706 can also communicatively couple with one or more servers 1730, computers 1740 (e.g., laptops, computers, etc.), mobile devices 1750 (e.g., smartphones, tablets, etc.), and/or other electronic devices via network 1725 (e.g., cellular, near field, Wi-Fi, personal area network, wireless LAN, etc.).

In FIG. 17, a user 1708 is shown wearing wrist-wearable device 1702 and AR glasses 1704 and having HIPD 1706 on their desk. The wrist-wearable device 1702, AR glasses 1704, and HIPD 1706 facilitate user interaction with an AR environment. In particular, as shown by first AR system 1700, wrist-wearable device 1702, AR glasses 1704, and/or HIPD 1706 cause presentation of one or more avatars 1710, digital representations of contacts 1712, and virtual objects 1714. As discussed below, user 1708 can interact with one or more avatars 1710, digital representations of contacts 1712, and virtual objects 1714 via wrist-wearable device 1702, AR glasses 1704, and/or HIPD 1706.

User 1708 can use any of wrist-wearable device 1702, AR glasses 1704, and/or HIPD 1706 to provide user inputs. For example, user 1708 can perform one or more hand gestures that are detected by wrist-wearable device 1702 (e.g., using one or more EMG sensors and/or IMUs, described below in reference to FIGS. 21 and 22) and/or AR glasses 1704 (e.g., using one or more image sensor or camera, described below in reference to FIGS. 23-10) to provide a user input. Alternatively, or additionally, user 1708 can provide a user input via one or more touch surfaces of wrist-wearable device 1702, AR glasses 1704, HIPD 1706, and/or voice commands captured by a microphone of wrist-wearable device 1702, AR glasses 1704, and/or HIPD 1706. In some embodiments, wrist-wearable device 1702, AR glasses 1704, and/or HIPD 1706 include a digital assistant to help user 1708 in providing a user input (e.g., completing a sequence of operations, suggesting different operations or commands, providing reminders, confirming a command, etc.). In some embodiments, user 1708 can provide a user input via one or more facial gestures and/or facial expressions. For example, cameras of wrist-wearable device 1702, AR glasses 1704, and/or HIPD 1706 can track eyes of user 1708 for navigating a user interface.

Wrist-wearable device 1702, AR glasses 1704, and/or HIPD 1706 can operate alone or in conjunction to allow user 1708 to interact with the AR environment. In some embodiments, HIPD 1706 is configured to operate as a central hub or control center for the wrist-wearable device 1702, AR glasses 1704, and/or another communicatively coupled device. For example, user 1708 can provide an input to interact with the AR environment at any of wrist-wearable device 1702, AR glasses 1704, and/or HIPD 1706, and HIPD 1706 can identify one or more back-end and front-end tasks to cause the performance of the requested interaction and distribute instructions to cause the performance of the one or more back-end and front-end tasks at wrist-wearable device 1702, AR glasses 1704, and/or HIPD 1706. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below, HIPD 1706 can perform the back-end tasks and provide wrist-wearable device 1702 and/or AR glasses 1704 operational data corresponding to the performed back-end tasks such that wrist-wearable device 1702 and/or AR glasses 1704 can perform the front-end tasks. In this way, HIPD 1706, which has more computational resources and greater thermal headroom than wrist-wearable device 1702 and/or AR glasses 1704, performs computationally intensive tasks and reduces the computer resource utilization and/or power usage of wrist-wearable device 1702 and/or AR glasses 1704.

In the example shown by first AR system 1700, HIPD 1706 identifies one or more back-end tasks and front-end tasks associated with a user request to initiate an AR video call with one or more other users (represented by avatar 1710 and the digital representation of contact 1712) and distributes instructions to cause the performance of the one or more back-end tasks and front-end tasks. In particular, HIPD 1706 performs back-end tasks for processing and/or rendering image data (and other data) associated with the AR video call and provides operational data associated with the performed back-end tasks to AR glasses 1704 such that the AR glasses 1704 perform front-end tasks for presenting the AR video call (e.g., presenting avatar 1710 and digital representation of contact 1712).

In some embodiments, HIPD 1706 can operate as a focal or anchor point for causing the presentation of information. This allows user 1708 to be generally aware of where information is presented. For example, as shown in first AR system 1700, avatar 1710 and the digital representation of contact 1712 are presented above HIPD 1706. In particular, HIPD 1706 and AR glasses 1704 operate in conjunction to determine a location for presenting avatar 1710 and the digital representation of contact 1712. In some embodiments, information can be presented a predetermined distance from HIPD 1706 (e.g., within 5 meters). For example, as shown in first AR system 1700, virtual object 1714 is presented on the desk some distance from HIPD 1706. Similar to the above example, HIPD 1706 and AR glasses 1704 can operate in conjunction to determine a location for presenting virtual object 1714. Alternatively, in some embodiments, presentation of information is not bound by HIPD 1706. More specifically, avatar 1710, digital representation of contact 1712, and virtual object 1714 do not have to be presented within a predetermined distance of HIPD 1706.

User inputs provided at wrist-wearable device 1702, AR glasses 1704, and/or HIPD 1706 are coordinated such that the user can use any device to initiate, continue, and/or complete an operation. For example, user 1708 can provide a user input to AR glasses 1704 to cause AR glasses 1704 to present virtual object 1714 and, while virtual object 1714 is presented by AR glasses 1704, user 1708 can provide one or more hand gestures via wrist-wearable device 1702 to interact and/or manipulate virtual object 1714.

FIG. 18 shows a user 1808 wearing a wrist-wearable device 1802 and AR glasses 1804, and holding an HIPD 1806. In second AR system 1800, the wrist-wearable device 1802, AR glasses 1804, and/or HIPD 1806 are used to receive and/or provide one or more messages to a contact of user 1808. In particular, wrist-wearable device 1802, AR glasses 1804, and/or HIPD 1806 detect and coordinate one or more user inputs to initiate a messaging application and prepare a response to a received message via the messaging application.

In some embodiments, user 1808 initiates, via a user input, an application on wrist-wearable device 1802, AR glasses 1804, and/or HIPD 1806 that causes the application to initiate on at least one device. For example, in second AR system 1800, user 1808 performs a hand gesture associated with a command for initiating a messaging application (represented by messaging user interface 1816), wrist-wearable device 1802 detects the hand gesture and, based on a determination that user 1808 is wearing AR glasses 1804, causes AR glasses 1804 to present a messaging user interface 1816 of the messaging application. AR glasses 1804 can present messaging user interface 1816 to user 1808 via its display (e.g., as shown by a field of view 1818 of user 1808). In some embodiments, the application is initiated and executed on the device (e.g., wrist-wearable device 1802, AR glasses 1804, and/or HIPD 1806) that detects the user input to initiate the application, and the device provides another device operational data to cause the presentation of the messaging application. For example, wrist-wearable device 1802 can detect the user input to initiate a messaging application, initiate and run the messaging application, and provide operational data to AR glasses 1804 and/or HIPD 1806 to cause presentation of the messaging application. Alternatively, the application can be initiated and executed at a device other than the device that detected the user input. For example, wrist-wearable device 1802 can detect the hand gesture associated with initiating the messaging application and cause HIPD 1806 to run the messaging application and coordinate the presentation of the messaging application.

Further, user 1808 can provide a user input provided at wrist-wearable device 1802, AR glasses 1804, and/or HIPD 1806 to continue and/or complete an operation initiated at another device. For example, after initiating the messaging application via wrist-wearable device 1802 and while AR glasses 1804 present messaging user interface 1816, user 1808 can provide an input at HIPD 1806 to prepare a response (e.g., shown by the swipe gesture performed on HIPD 1806). Gestures performed by user 1808 on HIPD 1806 can be provided and/or displayed on another device. For example, a swipe gestured performed on HIPD 1806 is displayed on a virtual keyboard of messaging user interface 1816 displayed by AR glasses 1804.

In some embodiments, wrist-wearable device 1802, AR glasses 1804, HIPD 1806, and/or any other communicatively coupled device can present one or more notifications to user 1808. The notification can be an indication of a new message, an incoming call, an application update, a status update, etc. User 1808 can select the notification via wrist-wearable device 1802, AR glasses 1804, and/or HIPD 1806 and can cause presentation of an application or operation associated with the notification on at least one device. For example, user 1808 can receive a notification that a message was received at wrist-wearable device 1802, AR glasses 1804, HIPD 1806, and/or any other communicatively coupled device and can then provide a user input at wrist-wearable device 1802, AR glasses 1804, and/or HIPD 1806 to review the notification, and the device detecting the user input can cause an application associated with the notification to be initiated and/or presented at wrist-wearable device 1802, AR glasses 1804, and/or HIPD 1806.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 1804 can present to user 1808 game application data, and HIPD 1806 can be used as a controller to provide inputs to the game. Similarly, user 1808 can use wrist-wearable device 1802 to initiate a camera of AR glasses 1804, and user 308 can use wrist-wearable device 1802, AR glasses 1804, and/or HIPD 1806 to manipulate the image capture (e.g., zoom in or out, apply filters, etc.) and capture image data.

Users may interact with the devices disclosed herein in a variety of ways. For example, as shown in FIGS. 19A and 19B, a user 1908 may interact with an AR system 1900 by donning a VR headset 1950 while holding HIPD 1906 and wearing wrist-wearable device 1902. In this example, AR system 1900 may enable a user to interact with a game 1910 by swiping their arm. One or more of VR headset 1950, HIPD 1906, and wrist-wearable device 1902 may detect this gesture and, in response, may display a sword strike in game 1910. Similarly, in FIGS. 20A and 20B, a user 2008 may interact with an AR system 2000 by donning a VR headset 2020 while wearing haptic device 2060 and wrist-wearable device 2030. In this example, AR system 2000 may enable a user to interact with a game 2010 by swiping their arm. One or more of VR headset 2020, haptic device 2060, and wrist-wearable device 2030 may detect this gesture and, in response, may display a spell being cast in game 1910.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user’s heart rate, (v) SpO2 sensors for measuring blood oxygen saturation and/or other biometric data of a user, (vi) capacitive sensors for detecting changes in potential at a portion of a user’s body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configured to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 2302.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 21 and 22 illustrate an example wrist-wearable device 2100 and an example computer system 2200, in accordance with some embodiments. Wrist-wearable device 2100 is an instance of wearable device 1702 described in FIG. 17 herein, such that the wearable device 1702 should be understood to have the features of the wrist-wearable device 2100 and vice versa. FIG. 22 illustrates components of the wrist-wearable device 2100, which can be used individually or in combination, including combinations that include other electronic devices and/or electronic components.

FIG. 21 shows a wearable band 2110 and a watch body 2120 (or capsule) being coupled, as discussed below, to form wrist-wearable device 2100. Wrist-wearable device 2100 can perform various functions and/or operations associated with navigating through user interfaces and selectively opening applications as well as the functions and/or operations described above with reference to FIGS. 17-20B.

As will be described in more detail below, operations executed by wrist-wearable device 2100 can include (i) presenting content to a user (e.g., displaying visual content via a display 2105), (ii) detecting (e.g., sensing) user input (e.g., sensing a touch on peripheral button 2123 and/or at a touch screen of the display 2105, a hand gesture detected by sensors (e.g., biopotential sensors)), (iii) sensing biometric data (e.g., neuromuscular signals, heart rate, temperature, sleep, etc.) via one or more sensors 2113, messaging (e.g., text, speech, video, etc.); image capture via one or more imaging devices or cameras 2125, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 2120, independently in wearable band 2110, and/or via an electronic communication between watch body 2120 and wearable band 2110. In some embodiments, functions can be executed on wrist-wearable device 2100 while an AR environment is being presented (e.g., via one of AR systems 1700 to 2000). The wearable devices described herein can also be used with other types of AR environments.

Wearable band 2110 can be configured to be worn by a user such that an inner surface of a wearable structure 2111 of wearable band 2110 is in contact with the user’s skin. In this example, when worn by a user, sensors 2113 may contact the user’s skin. In some examples, one or more of sensors 2113 can sense biometric data such as a user’s heart rate, a saturated oxygen level, temperature, sweat level, neuromuscular signals, or a combination thereof. One or more of sensors 2113 can also sense data about a user’s environment including a user’s motion, altitude, location, orientation, gait, acceleration, position, or a combination thereof. In some embodiment, one or more of sensors 2113 can be configured to track a position and/or motion of wearable band 2110. One or more of sensors 2113 can include any of the sensors defined above and/or discussed below with respect to FIG. 21.

One or more of sensors 2113 can be distributed on an inside and/or an outside surface of wearable band 2110. In some embodiments, one or more of sensors 2113 are uniformly spaced along wearable band 2110. Alternatively, in some embodiments, one or more of sensors 2113 are positioned at distinct points along wearable band 2110. As shown in FIG. 21, one or more of sensors 2113 can be the same or distinct. For example, in some embodiments, one or more of sensors 2113 can be shaped as a pill (e.g., sensor 2113a), an oval, a circle a square, an oblong (e.g., sensor 2113c) and/or any other shape that maintains contact with the user’s skin (e.g., such that neuromuscular signal and/or other biometric data can be accurately measured at the user’s skin). In some embodiments, one or more sensors of 2113 are aligned to form pairs of sensors (e.g., for sensing neuromuscular signals based on differential sensing within each respective sensor). For example, sensor 2113b may be aligned with an adjacent sensor to form sensor pair 2114a and sensor 2113d may be aligned with an adjacent sensor to form sensor pair 2114b. In some embodiments, wearable band 2110 does not have a sensor pair. Alternatively, in some embodiments, wearable band 2110 has a predetermined number of sensor pairs (one pair of sensors, three pairs of sensors, four pairs of sensors, six pairs of sensors, sixteen pairs of sensors, etc.).

Wearable band 2110 can include any suitable number of sensors 2113. In some embodiments, the number and arrangement of sensors 2113 depends on the particular application for which wearable band 2110 is used. For instance, wearable band 2110 can be configured as an armband, wristband, or chest-band that include a plurality of sensors 2113 with different number of sensors 2113, a variety of types of individual sensors with the plurality of sensors 2113, and different arrangements for each use case, such as medical use cases as compared to gaming or general day-to-day use cases.

In accordance with some embodiments, wearable band 2110 further includes an electrical ground electrode and a shielding electrode. The electrical ground and shielding electrodes, like the sensors 2113, can be distributed on the inside surface of the wearable band 2110 such that they contact a portion of the user’s skin. For example, the electrical ground and shielding electrodes can be at an inside surface of a coupling mechanism 2116 or an inside surface of a wearable structure 2111. The electrical ground and shielding electrodes can be formed and/or use the same components as sensors 2113. In some embodiments, wearable band 2110 includes more than one electrical ground electrode and more than one shielding electrode.

Sensors 2113 can be formed as part of wearable structure 2111 of wearable band 2110. In some embodiments, sensors 2113 are flush or substantially flush with wearable structure 2111 such that they do not extend beyond the surface of wearable structure 2111. While flush with wearable structure 2111, sensors 2113 are still configured to contact the user’s skin (e.g., via a skin-contacting surface). Alternatively, in some embodiments, sensors 2113 extend beyond wearable structure 2111 a predetermined distance (e.g., 0.1 – 2 mm) to make contact and depress into the user’s skin. In some embodiment, sensors 2113 are coupled to an actuator (not shown) configured to adjust an extension height (e.g., a distance from the surface of wearable structure 2111) of sensors 2113 such that sensors 2113 make contact and depress into the user’s skin. In some embodiments, the actuators adjust the extension height between 0.01 mm – 1.2 mm. This may allow a user to customize the positioning of sensors 2113 to improve the overall comfort of the wearable band 2110 when worn while still allowing sensors 2113 to contact the user’s skin. In some embodiments, sensors 2113 are indistinguishable from wearable structure 2111 when worn by the user.

Wearable structure 2111 can be formed of an elastic material, elastomers, etc., configured to be stretched and fitted to be worn by the user. In some embodiments, wearable structure 2111 is a textile or woven fabric. As described above, sensors 2113 can be formed as part of a wearable structure 2111. For example, sensors 2113 can be molded into the wearable structure 2111, be integrated into a woven fabric (e.g., sensors 2113 can be sewn into the fabric and mimic the pliability of fabric and can and/or be constructed from a series woven strands of fabric).

Wearable structure 2111 can include flexible electronic connectors that interconnect sensors 2113, the electronic circuitry, and/or other electronic components (described below in reference to FIG. 22) that are enclosed in wearable band 2110. In some embodiments, the flexible electronic connectors are configured to interconnect sensors 2113, the electronic circuitry, and/or other electronic components of wearable band 2110 with respective sensors and/or other electronic components of another electronic device (e.g., watch body 2120). The flexible electronic connectors are configured to move with wearable structure 2111 such that the user adjustment to wearable structure 2111 (e.g., resizing, pulling, folding, etc.) does not stress or strain the electrical coupling of components of wearable band 2110.

As described above, wearable band 2110 is configured to be worn by a user. In particular, wearable band 2110 can be shaped or otherwise manipulated to be worn by a user. For example, wearable band 2110 can be shaped to have a substantially circular shape such that it can be configured to be worn on the user’s lower arm or wrist. Alternatively, wearable band 2110 can be shaped to be worn on another body part of the user, such as the user’s upper arm (e.g., around a bicep), forearm, chest, legs, etc. Wearable band 2110 can include a retaining mechanism 2112 (e.g., a buckle, a hook and loop fastener, etc.) for securing wearable band 2110 to the user’s wrist or other body part. While wearable band 2110 is worn by the user, sensors 2113 sense data (referred to as sensor data) from the user’s skin. In some examples, sensors 2113 of wearable band 2110 obtain (e.g., sense and record) neuromuscular signals.

The sensed data (e.g., sensed neuromuscular signals) can be used to detect and/or determine the user’s intention to perform certain motor actions. In some examples, sensors 2113 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 2105 of wrist-wearable device 2100 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user’s hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 2113 can be used to provide a user with an enhanced interaction with a physical object (e.g., devices communicatively coupled with wearable band 2110) and/or a virtual object in an artificial-reality application generated by an artificial-reality system (e.g., user interface objects presented on the display 2105, or another computing device (e.g., a smartphone)).

In some embodiments, wearable band 2110 includes one or more haptic devices 2246 (e.g., a vibratory haptic actuator) that are configured to provide haptic feedback (e.g., a cutaneous and/or kinesthetic sensation, etc.) to the user’s skin. Sensors 2113 and/or haptic devices 2246 (shown in FIG. 22) can be configured to operate in conjunction with multiple applications including, without limitation, health monitoring, social media, games, and artificial reality (e.g., the applications associated with artificial reality).

Wearable band 2110 can also include coupling mechanism 2116 for detachably coupling a capsule (e.g., a computing unit) or watch body 2120 (via a coupling surface of the watch body 2120) to wearable band 2110. For example, a cradle or a shape of coupling mechanism 2116 can correspond to shape of watch body 2120 of wrist-wearable device 2100. In particular, coupling mechanism 2116 can be configured to receive a coupling surface proximate to the bottom side of watch body 2120 (e.g., a side opposite to a front side of watch body 2120 where display 2105 is located), such that a user can push watch body 2120 downward into coupling mechanism 2116 to attach watch body 2120 to coupling mechanism 2116. In some embodiments, coupling mechanism 2116 can be configured to receive a top side of the watch body 2120 (e.g., a side proximate to the front side of watch body 2120 where display 2105 is located) that is pushed upward into the cradle, as opposed to being pushed downward into coupling mechanism 2116. In some embodiments, coupling mechanism 2116 is an integrated component of wearable band 2110 such that wearable band 2110 and coupling mechanism 2116 are a single unitary structure. In some embodiments, coupling mechanism 2116 is a type of frame or shell that allows watch body 2120 coupling surface to be retained within or on wearable band 2110 coupling mechanism 2116 (e.g., a cradle, a tracker band, a support base, a clasp, etc.).

Coupling mechanism 2116 can allow for watch body 2120 to be detachably coupled to the wearable band 2110 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 2120 to wearable band 2110 and to decouple the watch body 2120 from the wearable band 2110. For example, a user can twist, slide, turn, push, pull, or rotate watch body 2120 relative to wearable band 2110, or a combination thereof, to attach watch body 2120 to wearable band 2110 and to detach watch body 2120 from wearable band 2110. Alternatively, as discussed below, in some embodiments, the watch body 2120 can be decoupled from the wearable band 2110 by actuation of a release mechanism 2129.

Wearable band 2110 can be coupled with watch body 2120 to increase the functionality of wearable band 2110 (e.g., converting wearable band 2110 into wrist-wearable device 2100, adding an additional computing unit and/or battery to increase computational resources and/or a battery life of wearable band 2110, adding additional sensors to improve sensed data, etc.). As described above, wearable band 2110 and coupling mechanism 2116 are configured to operate independently (e.g., execute functions independently) from watch body 2120. For example, coupling mechanism 2116 can include one or more sensors 2113 that contact a user’s skin when wearable band 2110 is worn by the user, with or without watch body 2120 and can provide sensor data for determining control commands.

A user can detach watch body 2120 from wearable band 2110 to reduce the encumbrance of wrist-wearable device 2100 to the user. For embodiments in which watch body 2120 is removable, watch body 2120 can be referred to as a removable structure, such that in these embodiments wrist-wearable device 2100 includes a wearable portion (e.g., wearable band 2110) and a removable structure (e.g., watch body 2120).

Turning to watch body 2120, in some examples watch body 2120 can have a substantially rectangular or circular shape. Watch body 2120 is configured to be worn by the user on their wrist or on another body part. More specifically, watch body 2120 is sized to be easily carried by the user, attached on a portion of the user’s clothing, and/or coupled to wearable band 2110 (forming the wrist-wearable device 2100). As described above, watch body 2120 can have a shape corresponding to coupling mechanism 2116 of wearable band 2110. In some embodiments, watch body 2120 includes a single release mechanism 2129 or multiple release mechanisms (e.g., two release mechanisms 2129 positioned on opposing sides of watch body 2120, such as spring-loaded buttons) for decoupling watch body 2120 from wearable band 2110. Release mechanism 2129 can include, without limitation, a button, a knob, a plunger, a handle, a lever, a fastener, a clasp, a dial, a latch, or a combination thereof.

A user can actuate release mechanism 2129 by pushing, turning, lifting, depressing, shifting, or performing other actions on release mechanism 2129. Actuation of release mechanism 2129 can release (e.g., decouple) watch body 2120 from coupling mechanism 2116 of wearable band 2110, allowing the user to use watch body 2120 independently from wearable band 2110 and vice versa. For example, decoupling watch body 2120 from wearable band 2110 can allow a user to capture images using rear-facing camera 2125b. Although release mechanism 2129 is shown positioned at a corner of watch body 2120, release mechanism 2129 can be positioned anywhere on watch body 2120 that is convenient for the user to actuate. In addition, in some embodiments, wearable band 2110 can also include a respective release mechanism for decoupling watch body 2120 from coupling mechanism 2116. In some embodiments, release mechanism 2129 is optional and watch body 2120 can be decoupled from coupling mechanism 2116 as described above (e.g., via twisting, rotating, etc.).

Watch body 2120 can include one or more peripheral buttons 2123 and 2127 for performing various operations at watch body 2120. For example, peripheral buttons 2123 and 2127 can be used to turn on or wake (e.g., transition from a sleep state to an active state) display 2105, unlock watch body 2120, increase or decrease a volume, increase or decrease a brightness, interact with one or more applications, interact with one or more user interfaces, etc. Additionally, or alternatively, in some embodiments, display 2105 operates as a touch screen and allows the user to provide one or more inputs for interacting with watch body 2120.

In some embodiments, watch body 2120 includes one or more sensors 2121. Sensors 2121 of watch body 2120 can be the same or distinct from sensors 2113 of wearable band 2110. Sensors 2121 of watch body 2120 can be distributed on an inside and/or an outside surface of watch body 2120. In some embodiments, sensors 2121 are configured to contact a user’s skin when watch body 2120 is worn by the user. For example, sensors 2121 can be placed on the bottom side of watch body 2120 and coupling mechanism 2116 can be a cradle with an opening that allows the bottom side of watch body 2120 to directly contact the user’s skin.

Alternatively, in some embodiments, watch body 2120 does not include sensors that are configured to contact the user’s skin (e.g., including sensors internal and/or external to the watch body 2120 that are configured to sense data of watch body 2120 and the surrounding environment). In some embodiments, sensors 2121 are configured to track a position and/or motion of watch body 2120.

Watch body 2120 and wearable band 2110 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 2120 and wearable band 2110 can share data sensed by sensors 2113 and 2121, as well as application and device specific information (e.g., active and/or available applications, output devices (e.g., displays, speakers, etc.), input devices (e.g., touch screens, microphones, imaging sensors, etc.).

In some embodiments, watch body 2120 can include, without limitation, a front-facing camera 2125a and/or a rear-facing camera 2125b, sensors 2121 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 2263), a touch sensor, a sweat sensor, etc.). In some embodiments, watch body 2120 can include one or more haptic devices 2276 (e.g., a vibratory haptic actuator) that is configured to provide haptic feedback (e.g., a cutaneous and/or kinesthetic sensation, etc.) to the user. Sensors 2221 and/or haptic device 2276 can also be configured to operate in conjunction with multiple applications including, without limitation, health monitoring applications, social media applications, game applications, and artificial reality applications (e.g., the applications associated with artificial reality).

As described above, watch body 2120 and wearable band 2110, when coupled, can form wrist-wearable device 2100. When coupled, watch body 2120 and wearable band 2110 may operate as a single device to execute functions (operations, detections, communications, etc.) described herein. In some embodiments, each device may be provided with particular instructions for performing the one or more operations of wrist-wearable device 2100. For example, in accordance with a determination that watch body 2120 does not include neuromuscular signal sensors, wearable band 2110 can include alternative instructions for performing associated instructions (e.g., providing sensed neuromuscular signal data to watch body 2120 via a different electronic device). Operations of wrist-wearable device 2100 can be performed by watch body 2120 alone or in conjunction with wearable band 2110 (e.g., via respective processors and/or hardware components) and vice versa. In some embodiments, operations of wrist-wearable device 2100, watch body 2120, and/or wearable band 2110 can be performed in conjunction with one or more processors and/or hardware components.

As described below with reference to the block diagram of FIG. 22, wearable band 2110 and/or watch body 2120 can each include independent resources required to independently execute functions. For example, wearable band 2110 and/or watch body 2120 can each include a power source (e.g., a battery), a memory, data storage, a processor (e.g., a central processing unit (CPU)), communications, a light source, and/or input/output devices.

FIG. 22 shows block diagrams of a computing system 2230 corresponding to wearable band 2110 and a computing system 2260 corresponding to watch body 2120 according to some embodiments. Computing system 2200 of wrist-wearable device 2100 may include a combination of components of wearable band computing system 2230 and watch body computing system 2260, in accordance with some embodiments.

Watch body 2120 and/or wearable band 2110 can include one or more components shown in watch body computing system 2260. In some embodiments, a single integrated circuit may include all or a substantial portion of the components of watch body computing system 2260 included in a single integrated circuit. Alternatively, in some embodiments, components of the watch body computing system 2260 may be included in a plurality of integrated circuits that are communicatively coupled. In some embodiments, watch body computing system 2260 may be configured to couple (e.g., via a wired or wireless connection) with wearable band computing system 2230, which may allow the computing systems to share components, distribute tasks, and/or perform other operations described herein (individually or as a single device).

Watch body computing system 2260 can include one or more processors 2279, a controller 2277, a peripherals interface 2261, a power system 2295, and memory (e.g., a memory 2280).

Power system 2295 can include a charger input 2296, a power-management integrated circuit (PMIC) 2297, and a battery 2298. In some embodiments, a watch body 2120 and a wearable band 2110 can have respective batteries (e.g., battery 2298 and 2259) and can share power with each other. Watch body 2120 and wearable band 2110 can receive a charge using a variety of techniques. In some embodiments, watch body 2120 and wearable band 2110 can use a wired charging assembly (e.g., power cords) to receive the charge. Alternatively, or in addition, watch body 2120 and/or wearable band 2110 can be configured for wireless charging. For example, a portable charging device can be designed to mate with a portion of watch body 2120 and/or wearable band 2110 and wirelessly deliver usable power to battery 2298 of watch body 2120 and/or battery 2259 of wearable band 2110. Watch body 2120 and wearable band 2110 can have independent power systems (e.g., power system 2295 and 2256, respectively) to enable each to operate independently. Watch body 2120 and wearable band 2110 can also share power (e.g., one can charge the other) via respective PMICs (e.g., PMICs 2297 and 2258) and charger inputs (e.g., 2257 and 2296) that can share power over power and ground conductors and/or over wireless charging antennas.

In some embodiments, peripherals interface 2261 can include one or more sensors 2221. Sensors 2221 can include one or more coupling sensors 2262 for detecting when watch body 2120 is coupled with another electronic device (e.g., a wearable band 2110). Sensors 2221 can include one or more imaging sensors 2263 (e.g., one or more of cameras 2225, and/or separate imaging sensors 2263 (e.g., thermal-imaging sensors)). In some embodiments, sensors 2221 can include one or more SpO2 sensors 2264. In some embodiments, sensors 2221 can include one or more biopotential-signal sensors (e.g., EMG sensors 2265, which may be disposed on an interior, user-facing portion of watch body 2120 and/or wearable band 2110). In some embodiments, sensors 2221 may include one or more capacitive sensors 2266. In some embodiments, sensors 2221 may include one or more heart rate sensors 2267. In some embodiments, sensors 2221 may include one or more IMU sensors 2268. In some embodiments, one or more IMU sensors 2268 can be configured to detect movement of a user’s hand or other location where watch body 2120 is placed or held.

In some embodiments, one or more of sensors 2221 may provide an example human-machine interface. For example, a set of neuromuscular sensors, such as EMG sensors 2265, may be arranged circumferentially around wearable band 2110 with an interior surface of EMG sensors 2265 being configured to contact a user’s skin. Any suitable number of neuromuscular sensors may be used (e.g., between 2 and 20 sensors). The number and arrangement of neuromuscular sensors may depend on the particular application for which the wearable device is used. For example, wearable band 2110 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 2279. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 2265 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 2261 includes a near-field communication (NFC) component 2269, a global-position system (GPS) component 2270, a long-term evolution (LTE) component 2271, and/or a Wi-Fi and/or Bluetooth communication component 2272. In some embodiments, peripherals interface 2261 includes one or more buttons 2273 (e.g., peripheral buttons 2123 and 2127 in FIG. 21), which, when selected by a user, cause operation to be performed at watch body 2120. In some embodiments, the peripherals interface 2261 includes one or more indicators, such as a light emitting diode (LED), to provide a user with visual indicators (e.g., message received, low battery, active microphone and/or camera, etc.).

Watch body 2120 can include at least one display 2105 for displaying visual representations of information or data to a user, including user-interface elements and/or three-dimensional virtual objects. The display can also include a touch screen for inputting user inputs, such as touch gestures, swipe gestures, and the like. Watch body 2120 can include at least one speaker 2274 and at least one microphone 2275 for providing audio signals to the user and receiving audio input from the user. The user can provide user inputs through microphone 2275 and can also receive audio output from speaker 2274 as part of a haptic event provided by haptic controller 2278. Watch body 2120 can include at least one camera 2225, including a front camera 2225a and a rear camera 2225b. Cameras 2225 can include ultra-wide-angle cameras, wide angle cameras, fish-eye cameras, spherical cameras, telephoto cameras, depth-sensing cameras, or other types of cameras.

Watch body computing system 2260 can include one or more haptic controllers 2278 and associated componentry (e.g., haptic devices 2276) for providing haptic events at watch body 2120 (e.g., a vibrating sensation or audio output in response to an event at the watch body 2120). Haptic controllers 2278 can communicate with one or more haptic devices 2276, such as electroacoustic devices, including a speaker of the one or more speakers 2274 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 2278 can provide haptic events to that are capable of being sensed by a user of watch body 2120. In some embodiments, one or more haptic controllers 2278 can receive input signals from an application of applications 2282.

In some embodiments, wearable band computing system 2230 and/or watch body computing system 2260 can include memory 2280, which can be controlled by one or more memory controllers of controllers 2277. In some embodiments, software components stored in memory 2280 include one or more applications 2282 configured to perform operations at the watch body 2120. In some embodiments, one or more applications 2282 may include games, word processors, messaging applications, calling applications, web browsers, social media applications, media streaming applications, financial applications, calendars, clocks, etc. In some embodiments, software components stored in memory 2280 include one or more communication interface modules 2283 as defined above. In some embodiments, software components stored in memory 2280 include one or more graphics modules 2284 for rendering, encoding, and/or decoding audio and/or visual data and one or more data management modules 2285 for collecting, organizing, and/or providing access to data 2287 stored in memory 2280. In some embodiments, one or more of applications 2282 and/or one or more modules can work in conjunction with one another to perform various tasks at the watch body 2120.

In some embodiments, software components stored in memory 2280 can include one or more operating systems 2281 (e.g., a Linux-based operating system, an Android operating system, etc.). Memory 2280 can also include data 2287. Data 2287 can include profile data 2288A, sensor data 2289A, media content data 2290, and application data 2291.

It should be appreciated that watch body computing system 2260 is an example of a computing system within watch body 2120, and that watch body 2120 can have more or fewer components than shown in watch body computing system 2260, can combine two or more components, and/or can have a different configuration and/or arrangement of the components. The various components shown in watch body computing system 2260 are implemented in hardware, software, firmware, or a combination thereof, including one or more signal processing and/or application-specific integrated circuits.

Turning to the wearable band computing system 2230, one or more components that can be included in wearable band 2110 are shown. Wearable band computing system 2230 can include more or fewer components than shown in watch body computing system 2260, can combine two or more components, and/or can have a different configuration and/or arrangement of some or all of the components. In some embodiments, all, or a substantial portion of the components of wearable band computing system 2230 are included in a single integrated circuit. Alternatively, in some embodiments, components of wearable band computing system 2230 are included in a plurality of integrated circuits that are communicatively coupled. As described above, in some embodiments, wearable band computing system 2230 is configured to couple (e.g., via a wired or wireless connection) with watch body computing system 2260, which allows the computing systems to share components, distribute tasks, and/or perform other operations described herein (individually or as a single device).

Wearable band computing system 2230, similar to watch body computing system 2260, can include one or more processors 2249, one or more controllers 2247 (including one or more haptics controllers 2248), a peripherals interface 2231 that can includes one or more sensors 2213 and other peripheral devices, a power source (e.g., a power system 2256), and memory (e.g., a memory 2250) that includes an operating system (e.g., an operating system 2251), data (e.g., data 2254 including profile data 2288B, sensor data 2289B, etc.), and one or more modules (e.g., a communications interface module 2252, a data management module 2253, etc.).

One or more of sensors 2213 can be analogous to sensors 2221 of watch body computing system 2260. For example, sensors 2213 can include one or more coupling sensors 2232, one or more SpO2 sensors 2234, one or more EMG sensors 2235, one or more capacitive sensors 2236, one or more heart rate sensors 2237, and one or more IMU sensors 2238.

Peripherals interface 2231 can also include other components analogous to those included in peripherals interface 2261 of watch body computing system 2260, including an NFC component 2239, a GPS component 2240, an LTE component 2241, a Wi-Fi and/or Bluetooth communication component 2242, and/or one or more haptic devices 2246 as described above in reference to peripherals interface 2261. In some embodiments, peripherals interface 2231 includes one or more buttons 2243, a display 2233, a speaker 2244, a microphone 2245, and a camera 2255. In some embodiments, peripherals interface 2231 includes one or more indicators, such as an LED.

It should be appreciated that wearable band computing system 2230 is an example of a computing system within wearable band 2110, and that wearable band 2110 can have more or fewer components than shown in wearable band computing system 2230, combine two or more components, and/or have a different configuration and/or arrangement of the components. The various components shown in wearable band computing system 2230 can be implemented in one or more of a combination of hardware, software, or firmware, including one or more signal processing and/or application-specific integrated circuits.

Wrist-wearable device 2100 with respect to FIG. 21 is an example of wearable band 2110 and watch body 2120 coupled together, so wrist-wearable device 2100 will be understood to include the components shown and described for wearable band computing system 2230 and watch body computing system 2260. In some embodiments, wrist-wearable device 2100 has a split architecture (e.g., a split mechanical architecture, a split electrical architecture, etc.) between watch body 2120 and wearable band 2110. In other words, all of the components shown in wearable band computing system 2230 and watch body computing system 2260 can be housed or otherwise disposed in a combined wrist-wearable device 2100 or within individual components of watch body 2120, wearable band 2110, and/or portions thereof (e.g., a coupling mechanism 2116 of wearable band 2110).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 2100 can be used in conjunction with a head-wearable device (e.g., AR system 2300 and VR system 2400) and/or an HIPD, and wrist-wearable device 2100 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR system 2300 and VR system 2400.

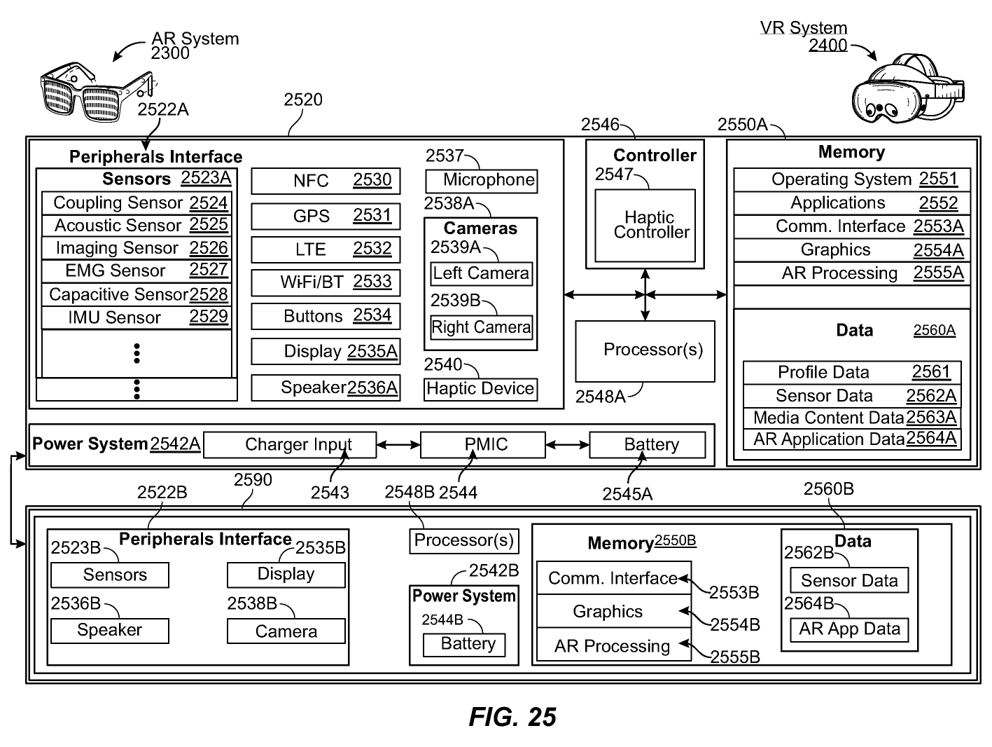

FIGS. 23 to 25 show example artificial-reality systems, which can be used as or in connection with wrist-wearable device 2100. In some embodiments, AR system 2300 includes an eyewear device 2302, as shown in FIG. 23. In some embodiments, VR system 2400 includes a head-mounted display (HMD) 2412, as shown in FIGS. 24A and 24B. In some embodiments, AR system 2300 and VR system 2400 can include one or more analogous components (e.g., components for presenting interactive artificial-reality environments, such as processors, memory, and/or presentation devices, including one or more displays and/or one or more waveguides), some of which are described in more detail with respect to FIG. 25. As described herein, a head-wearable device can include components of eyewear device 2302 and/or head-mounted display 2412. Some embodiments of head-wearable devices do not include any displays, including any of the displays described with respect to AR system 2300 and/or VR system 2400. While the example artificial-reality systems are respectively described herein as AR system 2300 and VR system 2400, either or both of the example AR systems described herein can be configured to present fully-immersive virtual-reality scenes presented in substantially all of a user’s field of view or subtler augmented-reality scenes that are presented within a portion, less than all, of the user’s field of view.

FIG. 23 show an example visual depiction of AR system 2300, including an eyewear device 2302 (which may also be described herein as augmented-reality glasses, and/or smart glasses). AR system 2300 can include additional electronic components that are not shown in FIG. 23, such as a wearable accessory device and/or an intermediary processing device, in electronic communication or otherwise configured to be used in conjunction with the eyewear device 2302. In some embodiments, the wearable accessory device and/or the intermediary processing device may be configured to couple with eyewear device 2302 via a coupling mechanism in electronic communication with a coupling sensor 2524 (FIG. 25), where coupling sensor 2524 can detect when an electronic device becomes physically or electronically coupled with eyewear device 2302. In some embodiments, eyewear device 2302 can be configured to couple to a housing 2590 (FIG. 25), which may include one or more additional coupling mechanisms configured to couple with additional accessory devices. The components shown in FIG. 23 can be implemented in hardware, software, firmware, or a combination thereof, including one or more signal-processing components and/or application-specific integrated circuits (ASICs).

Eyewear device 2302 includes mechanical glasses components, including a frame 2304 configured to hold one or more lenses (e.g., one or both lenses 2306-1 and 2306-2). One of ordinary skill in the art will appreciate that eyewear device 2302 can include additional mechanical components, such as hinges configured to allow portions of frame 2304 of eyewear device 2302 to be folded and unfolded, a bridge configured to span the gap between lenses 2306-1 and 2306-2 and rest on the user’s nose, nose pads configured to rest on the bridge of the nose and provide support for eyewear device 2302, earpieces configured to rest on the user’s ears and provide additional support for eyewear device 2302, temple arms configured to extend from the hinges to the earpieces of eyewear device 2302, and the like. One of ordinary skill in the art will further appreciate that some examples of AR system 2300 can include none of the mechanical components described herein. For example, smart contact lenses configured to present artificial reality to users may not include any components of eyewear device 2302.

Eyewear device 2302 includes electronic components, many of which will be described in more detail below with respect to FIG. 10. Some example electronic components are illustrated in FIG. 23, including acoustic sensors 2325-1, 2325-2, 2325-3, 2325-4, 2325-5, and 2325-6, which can be distributed along a substantial portion of the frame 2304 of eyewear device 2302. Eyewear device 2302 also includes a left camera 2339A and a right camera 2339B, which are located on different sides of the frame 2304. Eyewear device 2302 also includes a processor 2348 (or any other suitable type or form of integrated circuit) that is embedded into a portion of the frame 2304.

FIGS. 24A and 24B show a VR system 2400 that includes a head-mounted display (HMD) 2412 (e.g., also referred to herein as an artificial-reality headset, a head-wearable device, a VR headset, etc.), in accordance with some embodiments. As noted, some artificial-reality systems (e.g., AR system 2300) may, instead of blending an artificial reality with actual reality, substantially replace one or more of a user’s visual and/or other sensory perceptions of the real world with a virtual experience (e.g., AR systems 1900 and 2000).

HMD 2412 includes a front body 2414 and a frame 2416 (e.g., a strap or band) shaped to fit around a user’s head. In some embodiments, front body 2414 and/or frame 2416 include one or more electronic elements for facilitating presentation of and/or interactions with an AR and/or VR system (e.g., displays, IMUs, tracking emitter or detectors). In some embodiments, HMD 2412 includes output audio transducers (e.g., an audio transducer 2418), as shown in FIG. 24B. In some embodiments, one or more components, such as the output audio transducer(s) 2418 and frame 2416, can be configured to attach and detach (e.g., are detachably attachable) to HMD 2412 (e.g., a portion or all of frame 2416, and/or audio transducer 2418), as shown in FIG. 24B. In some embodiments, coupling a detachable component to HMD 2412 causes the detachable component to come into electronic communication with HMD 2412.

FIGS. 24A and 24B also show that VR system 2400 includes one or more cameras, such as left camera 2439A and right camera 2439B, which can be analogous to left and right cameras 2339A and 2339B on frame 2304 of eyewear device 2302. In some embodiments, VR system 2400 includes one or more additional cameras (e.g., cameras 2439Cand 2439D), which can be configured to augment image data obtained by left and right cameras 2439A and 2439B by providing more information. For example, camera 2439C can be used to supply color information that is not discerned by cameras 2439A and 2439B. In some embodiments, one or more of cameras 2439A to 2439D can include an optional IR cut filter configured to remove IR light from being received at the respective camera sensors.

FIG. 25 illustrates a computing system 2520 and an optional housing 2590, each of which show components that can be included in AR system 2300 and/or VR system 2400. In some embodiments, more or fewer components can be included in optional housing 2590 depending on practical restraints of the respective AR system being described.

In some embodiments, computing system 2520 can include one or more peripherals interfaces 2522A and/or optional housing 2590 can include one or more peripherals interfaces 2522B. Each of computing system 2520 and optional housing 2590 can also include one or more power systems 2542A and 2542B, one or more controllers 2546 (including one or more haptic controllers 2547), one or more processors 2548A and 2548B (as defined above, including any of the examples provided), and memory 2550A and 2550B, which can all be in electronic communication with each other. For example, the one or more processors 2548A and 2548B can be configured to execute instructions stored in memory 2550A and 2550B, which can cause a controller of one or more of controllers 2546 to cause operations to be performed at one or more peripheral devices connected to peripherals interface 2522A and/or 2522B. In some embodiments, each operation described can be powered by electrical power provided by power system 2542A and/or 2542B.

In some embodiments, peripherals interface 2522A can include one or more devices configured to be part of computing system 2520, some of which have been defined above and/or described with respect to the wrist-wearable devices shown in FIGS. 21 and 22. For example, peripherals interface 2522A can include one or more sensors 2523A. Some example sensors 2523A include one or more coupling sensors 2524, one or more acoustic sensors 2525, one or more imaging sensors 2526, one or more EMG sensors 2527, one or more capacitive sensors 2528, one or more IMU sensors 2529, and/or any other types of sensors explained above or described with respect to any other embodiments discussed herein.

In some embodiments, peripherals interfaces 2522A and 2522B can include one or more additional peripheral devices, including one or more NFC devices 2530, one or more GPS devices 2531, one or more LTE devices 2532, one or more Wi-Fi and/or Bluetooth devices 2533, one or more buttons 2534 (e.g., including buttons that are slidable or otherwise adjustable), one or more displays 2535A and 2535B, one or more speakers 2536A and 2536B, one or more microphones 2537, one or more cameras 2538A and 2538B (e.g., including the left camera 2539A and/or a right camera 2539B), one or more haptic devices 2540, and/or any other types of peripheral devices defined above or described with respect to any other embodiments discussed herein.

AR systems can include a variety of types of visual feedback mechanisms (e.g., presentation devices). For example, display devices in AR system 2300 and/or VR system 2400 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user’s vision. Some embodiments of AR systems also include optical subsystems having one or more lenses (e.g., conventional concave or convex lenses, Fresnel lenses, or adjustable liquid lenses) through which a user can view a display screen.

For example, respective displays 2535A and 2535B can be coupled to each of the lenses 2306-1 and 2306-2 of AR system 2300. Displays 2535A and 2535B may be coupled to each of lenses 2306-1 and 2306-2, which can act together or independently to present an image or series of images to a user. In some embodiments, AR system 2300 includes a single display 2535A or 2535B (e.g., a near-eye display) or more than two displays 2535A and 2535B. In some embodiments, a first set of one or more displays 2535A and 2535B can be used to present an augmented-reality environment, and a second set of one or more display devices 2535A and 2535B can be used to present a virtual-reality environment. In some embodiments, one or more waveguides are used in conjunction with presenting artificial-reality content to the user of AR system 2300 (e.g., as a means of delivering light from one or more displays 2535A and 2535B to the user’s eyes). In some embodiments, one or more waveguides are fully or partially integrated into the eyewear device 2302. Additionally, or alternatively to display screens, some artificial-reality systems include one or more projection systems. For example, display devices in AR system 2300 and/or VR system 2400 can include micro-LED projectors that project light (e.g., using a waveguide) into display devices, such as clear combiner lenses that allow ambient light to pass through. The display devices can refract the projected light toward a user’s pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 2535A and 2535B.

Computing system 2520 and/or optional housing 2590 of AR system 2300 or VR system 2400 can include some or all of the components of a power system 2542A and 2542B. Power systems 2542A and 2542B can include one or more charger inputs 2543, one or more PMICs 2544, and/or one or more batteries 2545A and 2544B.

Memory 2550A and 2550B may include instructions and data, some or all of which may be stored as non-transitory computer-readable storage media within the memories 2550A and 2550B. For example, memory 2550A and 2550B can include one or more operating systems 2551, one or more applications 2552, one or more communication interface applications 2553A and 2553B, one or more graphics applications 2554A and 2554B, one or more AR processing applications 2555A and 2555B, and/or any other types of data defined above or described with respect to any other embodiments discussed herein.

Memory 2550A and 2550B also include data 2560A and 2560B, which can be used in conjunction with one or more of the applications discussed above. Data 2560A and 2560B can include profile data 2561, sensor data 2562A and 2562B, media content data 2563A, AR application data 2564A and 2564B, and/or any other types of data defined above or described with respect to any other embodiments discussed herein.

In some embodiments, controller 2546 of eyewear device 2302 may process information generated by sensors 2523A and/or 2523Bon eyewear device 2302 and/or another electronic device within AR system 2300. For example, controller 2546 can process information from acoustic sensors 2325-1 and 2325-2. For each detected sound, controller 2546 can perform a direction of arrival (DOA) estimation to estimate a direction from which the detected sound arrived at eyewear device 2302 of AR system 2300. As one or more of acoustic sensors 2525 (e.g., the acoustic sensors 2325-1, 2325-2) detects sounds, controller 2546 can populate an audio data set with the information (e.g., represented as sensor data 2562A and 2562B).

In some embodiments, a physical electronic connector can convey information between eyewear device 2302 and another electronic device and/or between one or more processors 2348, 2548A, 2548B of AR system 2300 or VR system 2400 and controller 2546. The information can be in the form of optical data, electrical data, wireless data, or any other transmittable data form. Moving the processing of information generated by eyewear device 2302 to an intermediary processing device can reduce weight and heat in the eyewear device, making it more comfortable and safer for a user. In some embodiments, an optional wearable accessory device (e.g., an electronic neckband) is coupled to eyewear device 2302 via one or more connectors. The connectors can be wired or wireless connectors and can include electrical and/or non-electrical (e.g., structural) components. In some embodiments, eyewear device 2302 and the wearable accessory device can operate independently without any wired or wireless connection between them.

In some situations, pairing external devices, such as an intermediary processing device (e.g., HIPD 1706, 1806, 1906) with eyewear device 2302 (e.g., as part of AR system 2300) enables eyewear device 2302 to achieve a similar form factor of a pair of glasses while still providing sufficient battery and computation power for expanded capabilities. Some, or all, of the battery power, computational resources, and/or additional features of AR system 2300 can be provided by a paired device or shared between a paired device and eyewear device 2302, thus reducing the weight, heat profile, and form factor of eyewear device 2302 overall while allowing eyewear device 2302 to retain its desired functionality. For example, the wearable accessory device can allow components that would otherwise be included on eyewear device 2302 to be included in the wearable accessory device and/or intermediary processing device, thereby shifting a weight load from the user’s head and neck to one or more other portions of the user’s body. In some embodiments, the intermediary processing device has a larger surface area over which to diffuse and disperse heat to the ambient environment. Thus, the intermediary processing device can allow for greater battery and computation capacity than might otherwise have been possible on eyewear device 2302 standing alone. Because weight carried in the wearable accessory device can be less invasive to a user than weight carried in the eyewear device 2302, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user’s day-to-day activities.

AR systems can include various types of computer vision components and subsystems. For example, AR system 2300 and/or VR system 2400 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use’s real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 24A and 24B show VR system 2400 having cameras 2439A to 2439D, which can be used to provide depth information for creating a voxel field and a two-dimensional mesh to provide object information to the user to avoid collisions.

In some embodiments, AR system 2300 and/or VR system 2400 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 2300 and/or VR system 2400, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user’s field of view (e.g., a portion of the AR environment co-located with a physical object in the user’s real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to an organic solid crystal material that comprises or includes anthracene include embodiments where an organic solid crystal material consists essentially of anthracene and embodiments where an organic solid crystal material consists of anthracene.

What is claimed is:

1. A composite material comprising:
a polymer matrix; and
particles of an organic solid crystal material dispersed throughout the polymer matrix,
wherein the particles comprise 10 to 90 percent by weight of the composite material, and
the composite material has a refractive index of 1.7 to 2.7 along at least one dimension.

2. The composite material of claim 1, wherein the polymer matrix comprises a polymer selected from the group consisting of polycarbonate, polymethyl methacrylate, polystyrene, polyphenylene sulfide, polyfluorene polymer, acrylonitrile butadiene styrene, polyimide, polyethylene naphthalate, polyethylene terephthalate, polybutylene naphthalate, and polybutylene terephthalate.

3. The composite material of claim 1, wherein the polymer matrix comprises a hydrogel.

4. The composite material of claim 1, wherein the particles comprise nanoscale particles.

5. The composite material of claim 1, wherein the composite material is optically isotropic.

6. The composite material of claim 1, wherein the composite material is optically anisotropic.

7. The composite material of claim 1, wherein the composite material has a birefringence of 0.001 to 1.

8. The composite material of claim 1, wherein the composite material comprises a planar structure having an in-plane refractive index greater than an out-of-plane refractive index.

9. The composite material of claim 1, wherein the composite material comprises a planar structure having an out-of-plane refractive index greater than an in-plane refractive index.

10. The composite material of claim 1, wherein the composite material has a visible spectrum transmittance of at least approximately 80% or a near infrared spectrum transmittance of at least approximately 60%.

11. An optical element comprising:
a substrate configured to guide light; and
a plurality of diffractive grating elements disposed over the substrate, wherein the diffractive grating elements comprise an organic solid crystal composite having a polymer matrix and particles of an organic solid crystal material dispersed throughout the matrix.

12. The optical element of claim 11, wherein the substrate comprises a planar surface.

13. The optical element of claim 11, wherein the substrate comprises a non-planar surface.

14. The optical element of claim 11, wherein the diffractive grating elements have a shape selected from the group consisting of slanted, blazed, ruled, and triangular, and have an inter-element spacing of 50 to 1000 nm.

15. A multilayer optical element comprising:
a plurality of alternating first and second layers, wherein the first layers comprise an organic solid crystal composite having a polymer matrix and particles of an organic solid crystal material dispersed throughout the matrix.

16. The multilayer optical element of claim 15, wherein the first layers have a refractive index of at least approximately 1.5 and a birefringence of at least approximately 0.05.

17. The multilayer optical element of claim 15, wherein the first layers have refractive indices nₓ n_{y} n_{z} with nₓ1> .5, n_{y}1> .5, and n_{z}1-5> 1.5.

18. The multilayer optical element of claim 15, wherein the first layers are optically isotropic.

19. The multilayer optical element of claim 15, wherein the first layers are optically anisotropic.

20. The multilayer optical element of claim 15, wherein the second layers comprise an organic solid crystal composite having a polymer matrix and particles of an organic solid crystal material dispersed throughout the matrix.
